(19) United States
(12) Patent Application Publication
(10) Pub. No.: US 2007/0171912 A1
(43) Pub. Date: Jul. 26, 2007

(54) Network relay method and device

(75) Inventor: Yasuyuki Mitsumori, Kawasaki (JP)

Correspondence Address: KATTEN MUCHIN ROSENMAN LLP, 575 MADISON AVENUE, NEW YORK, NY, 10022-2585, US

(73) Assignee: FUJITSU LIMITED

(21) Appl. No.: 11/633,308

(22) Filed: Dec. 4, 2006

(30) Foreign Application Priority Data
Jan. 26, 2006 (JP) 2006-017407

(51) Int. Cl. H04L 12/56

(52) U.S. Cl. 370/395.1

(57) ABSTRACT

By a method and device which improve a transmission efficiency on an ATM transmission line upon network relay between an ATM cell and an Ethernet frame which is a variable length frame of a predetermined specification, a frame of a nonstandard frame format is generated, in which header information free from troubles in an end-to-end transfer even if the information is deleted from the Ethernet frame of a standard frame format for inter-layer conversion is deleted therefrom, and a plurality of ATM cells are generated from the frame of the nonstandard frame format. Also, by performing a reverse operation, the Ethernet frame is generated from the ATM cell. Also, it is made possible to statically or dynamically select the standard frame format and the nonstandard frame format, so that the network relay is realized by performing a conversion between the Ethernet frame and the ATM cell.

### BACKGROUND OF THE INVENTION

1. Field of the Invention

The present invention relates to a network relay method and device, and in particular to an efficient relay method of an Ethernet (registered trademark) frame and an ATM cell in an Ethernet Over ATM technology by which the Ethernet frame is transmitted over an ATM network as a relay network.

2. Description of the Related Art

As for an Ethernet Over ATM technology transmitting an Ethernet frame (variable length frame of a predetermined specification or standard) by using an ATM technology, IETF RFC 1483 and RFC 2684 can be mentioned as a standard technology. It is to be noted that the RFC 2684 includes the RFC 1483.

FIGS. 28A and 28B show a standard ATM capsuling method (ATM cellulating method), that is a process of generating an ATM cell from an Ethernet frame FR_{E} through a standard AAL5 (LLC Encapsulation for Bridged) frame FR_{A1} prescribed by the RFC 2684, where AAL is an abbreviation of ATM Adaptation Layer and the AAL5 frame is a frame for inter-layer conversion arranged between an ATM layer and an upper layer in order to offer a function required from the upper layer such as the Ethernet.

In a general example shown in FIG. 28A, the Ethernet frame FR_{E} is firstly capsuled into a standard AAL5 frame FR_{A1}, which has a frame format of an ATM Adaptation Layer Type 5 frame, and the following additional information is attached to the head and the end of the Ethernet frame FR_{E}:

Firstly, the following LLC, OUI, PID, and PAD are attached to the head of the frame as header information of the standard AAL5 frame FR_{A1}:
LLC is an abbreviation of Logical Link Layer, which is provided with a 3-byte fixed value of 0xAA-AA-03.
OUI is an abbreviation of Organizationally Unique Identifier, which is provided with a 3-byte fixed value of 0x00-80-C2.
PID is an abbreviation of Protocol Identifier, which is provided with a 2-byte fixed value of 0x00-01 or 0x00-07.
PAD is an abbreviation of Padding, which is provided with a 2-byte fixed value of 0x00-00.

Also, as trailer information of the standard AAL5 frame FR_{A1}, the following PAD, CPCS-UU, CPI, Length, and CRC are attached to the end of the frame:
PAD is an abbreviation of Padding, for adjusting the length of the AAL5 frame to the payload length of the 48-byte length cell, different from the PAD of the header information of the AAL5 frame previously described. The length of the PAD is 0-47 bytes.
CPCS-UU is an abbreviation of Common Part Convergence Sublayer User to User, and a 1-byte area which is freely available for an end-to-end user. Generally, 0x00 is used.
CPI is an abbreviation of Common Part Indicator, which is provided with a 1-byte fixed value of 0x00.
Length indicates a packet length, displaying a frame byte length from the head LLC portion of the AAL5 frame to the subsequent PAD.
CRC is an abbreviation of Cyclic Redundancy Check, having a general cyclic redundant checking bit, whose length is 4 bytes.

Also, in the case of PID=0x00-01, FCS information of the Ethernet frame is included in the frame, so that the frame is converted into the standard AAL5 frame. In the case of PID=0x00-07, the FCS information of the Ethernet frame is excluded, so that the frame is converted into the standard AAL5 frame.

In this example, FIG. 28A shows the standard AAL5 frame format including the FCS information in the case of PID=0x0-01.

The standard AAL5 frame FR_{A1} is disassembled into a plurality of ATM cells CL_{A}. Each ATM cell CL_{A} is a 53-byte standard fixed length cell, which is composed of a header portion (5 bytes) and a payload portion (48 bytes). The disassembled standard AAL5 frame FR_{A1} is sequentially stored in the payload portion, and is transmitted to the ATM network as an ATM cell CL_{A}.

FIG. 28B shows a specific example when the Ethernet frame (128 bytes) is converted into an ATM cell upon using the standard AAL5 frame format. When the standard AAL5 frame format is used, the Ethernet frame (128 bytes) is disassembled into 4 cells as shown.

As for the ATM cell CL_{A} received by an opposed device, the standard AAL5 frame portion is extracted from the payload portion to be re-assembled into the standard AAL5 frame by tracing the reverse process of FIGS. 28A and 28B. Then, the normality of a CRC check or the like is determined. The standard AAL5 frame FR_{A1} determined to be normal has additional information attached to the header and the trailer deleted therefrom, and is finally transmitted to the Ethernet transmission line as the Ethernet frame FR_{E}.

On the other hand, an AAL processing method of an ATM cell is known, in which an AAL identifying portion determines an AAL type of an ATM cell from an exchange by its VCI value, the ATM cell is transmitted to a cell multiplexing portion as it is through a standard cell relay portion when the cell is a standard cell other than an AAL type 2, and the ATM cell is disassembled per short cells included therein by an AAL2 disassembling/assembling portion when the cell is the AAL type 2 cell, and is assembled by adding the same header as the original ATM cell, the cell multiplexing portion multiplexes the cells to be transmitted to an AAL terminating portion by a common bus, the AAL terminating portion determines a destination by referring to a CID for the AAL2 cell, determines a destination from the VCI for the standard cell, and performs processing per AAL type (see e.g. patent document 1).

By this prior art, the standard ATM cell and the AAL2 cell transmitted and received on the transmission line can be identified by the VCI value. The AAL2 cell is once disassembled, and reassembled into the standard cell to be transferred to an ATM cell terminating portion at the subsequent stage as a standard cell, thereby enabling the ATM terminating portion to be shared by the standard cell and the AAL2 cell received from the transmission line.

Furthermore, a bandwidth reduction ATM network and method thereof are known, in which an ATM (asynchronous transfer mode) network has a compression device for compressing an ATM cell header without affecting a virtual circuit established for a call, a strengthened ATM network, and an extension device restoring a compressed header located at a call destination switch to its original form, the compression device identifies the first and the last cells of a call as master cells and intermediate cells as slave cells, transmits to the strengthened ATM network both of the master cells not compressed after the compression of the slave cell headers and the slave cells whose headers are compressed, the strengthened ATM network identifies the master (non-compressed) cells and the slave (compressed) cells, removes a free byte having occurred from the compressed cells by the compression, and transmits to the extension device payloads including both cells after having realized the bandwidth reduction, and the extension device restores the compressed headers to their original forms (see. e.g. patent document 2).

This prior art premises the ATM network where an end-to-end call of an ATM connection is established and cell headers (VPI and VCI) of the ATM cell flowing over a physical link are unchanged until the call is disconnected. Under the premise, a constant transmission of the ATM cell header (5 bytes) consumes a bandwidth. Therefore, when the end-to-end call is established, an ATM cell header is attached only to the first cell and the ATM cell headers are deleted from the following ATM cells to be transmitted, thereby preventing the consumption of the bandwidth.
[Patent Document 1] Japanese Patent Application Laid-open No. 2000-41051
[Patent Document 2] Japanese Patent Application Laid-open No. 10-93588

While the AAL5 frame format has been prescribed as the standard technology in the prior art as shown in FIGS. 28A and 28B, a transmission efficiency on the ATM network deteriorates by attaching additional information of 10 bytes to the head and 8 bytes (except PAD) to the end with respect to the Ethernet frame to be inherently transmitted. Specifically, due to a variable length of the Ethernet frame, there has been a problem that the shorter the frame length becomes, the higher the ratio of the additional information of the AAL5 frame to the Ethernet frame becomes, and more remarkable the reduction of the transmission efficiency becomes.

### SUMMARY OF THE INVENTION

It is accordingly an object of the present invention to provide a method and device which improve a transmission efficiency of an ATM transmission line upon network relay between an ATM cell and an Ethernet frame which is a variable length frame of a predetermined specification.
[1] In order to achieve the above-mentioned object, a network relay method (device) by one aspect of the present invention comprises: a first step of (means) generating, from a variable length frame of a predetermined specification, a frame of a nonstandard frame format in which header information free from troubles in an end-to-end transfer even if the information is deleted from a standard frame format for inter-layer conversion is deleted therefrom; and a second step of (means) generating a plurality of ATM cells from the frame of the nonstandard frame format.

Namely, in one aspect of the present invention, as shown in FIG. 1A, by using a nonstandard unique AAL5 frame format different from the above-mentioned standard AAL5 frame format, an Ethernet frame FR_{E} which is a variable length frame of a predetermined specification is converted into a nonstandard frame format frame FR_{A21}, and then an ATM cell CL_{A} is generated, thereby improving the transmission efficiency on the ATM transmission line.

Compared with the standard AAL5 frame format shown in FIGS. 28A and 28B, additional information of LLC, OUI, PID, and PAD attached to the head of the Ethernet frame and CPCS-UU and CPI attached to the end of the frame is deleted from the nonstandard AAL5 frame format, thereby reducing the overhead. This is because the additional information LLC, OUI, PID, PAD, CPCS-UU, and CPI is normally a fixed value, without which no problem is caused in an end-to-end Ethernet Over ATM transfer. On the other hand, in FIG. 1A, PAD (0-47 bytes) required for cell assembling/disassembling, Length (2 bytes), and an error detecting CRC (4 bytes) are left as necessary additional information.

FIG. 1B shows a specific example when the Ethernet frame (128 bytes) is converted into an ATM cell upon using the nonstandard AAL5 frame format. When the nonstandard AAL5 frame format is used, the Ethernet frame (128 bytes) is divided into 3 cells.

When the Ethernet frame is thus converted into the ATM cell by using the nonstandard AAL5 frame format, it becomes possible to reduce the number of transmission cells compared with that in the prior art in which the Ethernet frame is converted into the ATM cell by using the standard AAL5 frame format. In a communication state sequentially transmitting just the Ethernet frames of 128 bytes, the transmission efficiency of the Ethernet frame on the ATM transmission line is increased by approximately 33% (4:3).
[2] While the above-mentioned [1] indicates the network relay method (device) for generating the ATM cell from the variable length frame of a predetermined specification, another aspect of the present invention similarly provides a network relay method (device) for generating the variable length frame from the ATM cell.

Namely, a network relay method (device) in this case comprises: a first step of (means) extracting payloads of a plurality of ATM cells generated from a frame of a nonstandard frame format in which header information free from troubles in an end-to-end transfer even if the information is deleted from a standard frame format for inter-layer conversion is deleted therefrom and of assembling the frame of the nonstandard frame format; and a second step of (means) generating a variable length frame of a predetermined specification from the frame of the nonstandard frame format assembled at the first step (means).

In this case, payloads of ATM cells CL_{A} generated and transmitted as shown in FIGS. 1A and 1B are extracted, and the frame FR_{A21} of the nonstandard AAL5 frame format is assembled. From the assembled frame FR_{A21} of the nonstandard frame format, the Ethernet frame FR_{E} which is a variable length frame of a predetermined specification is generated, which is a reverse process to a generation process of the ATM cell.
[3] Also, in other aspect of the present invention, a network relay method (device) is provided, which comprises: a first step of (means) generating a frame of a nonstandard frame format or a standard frame format from a variable length frame of a predetermined specification based on a selection signal selecting either the standard frame format for inter-layer conversion or the nonstandard frame format in which header information free from troubles in an end-to-end transfer even if the information is deleted from the standard frame format is deleted therefrom; and a second step of (means) generating a plurality of ATM cells from the frame generated at the first step (means).

In this case, the standard AAL5 frame format and the nonstandard AAL5 frame format can be mounted or implemented. Either frame format is preset in a selection signal, so that a plurality of ATM cells are generated from the variable length frame of a predetermined specification based on the selection signal in the same way as the above-mentioned invention. Thus, the present invention can be realized for the ATM network composed of devices only mounting thereon the standard AAL5 frame format by statically selecting the ATM cellulating method.
[4] As for the above-mentioned [3], in order to similarly convert the ATM cells into the variable length frame, a network relay method (device) of another aspect of the present invention comprises: a first step of (means) extracting payloads of a plurality of ATM cells and assembling the payloads into a frame; and a second step of (means) generating a variable length frame of a predetermined specification from a frame of either a standard frame format or a nonstandard frame format assembled at the first step (means) based on a selection signal selecting either the standard frame format for inter-layer conversion or the nonstandard frame format in which header information free from troubles in an end-to-end transfer even if the information is deleted from the standard frame format is deleted therefrom.
[5] Also, in another aspect of the present invention, a network relay method (device) is provided, which comprises: a first step of (means) generating, from header information of a variable length frame of a predetermined specification, a selection signal indicating whether a preset value of VPI or VCI in the header information corresponds to either a standard frame format for inter-layer conversion or a nonstandard frame format in which the header information free from troubles in an end-to-end transfer even if the information is deleted from the standard frame format is deleted therefrom; a second step of (means) generating the frame of the standard frame format or the nonstandard frame format from the variable length frame based on the selection signal; and a third step of (means) generating a plurality of ATM cells from the frame generated at the second step (means).

Namely, in the same way as the above-mentioned [3] and [4], when both of the ATM cell generation method using the nonstandard frame format and the ATM cell generation method using the standard frame format are mounted thereon, a static selection of the ATM cellulating method per VP (Virtual Path Identifier) or VC (Virtual Connection) is enabled. According to the frame format to which the preset value of the VPI or the VCI corresponds, the ATM cells are generated from the variable length frame through the standard frame format or the nonstandard frame format.
[6] As for the above-mentioned [5], a network relay method in this case similarly comprises: a first step of extracting payloads of a plurality of ATM cells and assembling the payloads into a frame; a second step of generating, from header information of a frame assembled at the first step, a selection signal indicating whether a preset value of VPI or VCI in the header information corresponds to either a standard frame format for inter-layer conversion or a nonstandard frame format in which the header information free from troubles in an end-to-end transfer even if the information is deleted from the standard frame format is deleted therefrom; and a third step of generating a variable length frame of a predetermined specification from the frame of the standard frame format or the nonstandard frame format assembled at the first step based on the selection signal.

In the network relay device in this case, the second means may include a third means generating, from header information of a frame assembled by the first means, a selection signal indicating whether a preset value of VPI or VCI in the header information corresponds to either the standard frame format or the nonstandard frame format; and a fourth means generating the variable length frame from the frame of the standard frame format or the nonstandard frame format assembled by the first means based on the selection signal.
[7] Also, another aspect of the present invention may further include a step of (means) inquiring of an opposed device whether or not the opposed device can deal with either the standard frame format or the nonstandard frame format and of generating the selection signal corresponding to either the VPI or the VCI upon inquiry.

Namely, in addition to whether the frame is the standard frame format or the nonstandard frame format is statically determined and selected based on the header information of the frame received as mentioned above, the present invention dynamically generates a selection signal indicating whether the frame deals with either the standard frame format or the nonstandard frame format by inquiring of an opposed device about the format, thereby generating the ATM cell of the variable length frame.
[8] In the above-mentioned [7], the inquiry to the opposed device may be performed by using a signaling cell or an OAM cell.

Namely, by using an ATM signaling cell for call setting upon VP or VC establishment, whether or not the opposed device mounts thereon the nonstandard frame format method can be determined. Alternatively, by similarly inquiring whether or not the opposed device mounts thereon the ATM cellulating method of the nonstandard frame format by using an OAM cell, the standard frame format or the nonstandard frame format can be dynamically selected per VPI or VCI, so that the ATM cell or the variable length frame can be generated.
[9] Also, the above-mentioned selection signal may have a signal enabling a selection of frames of both frame formats; and the third step (fourth means) may include, when the selection signal generated at the second step (third means) selects both of the frame formats, a fourth step of (fifth means) generating the variable length frame only when the frame assembled at the first step (means) corresponds to the standard frame format, and a fifth step of (sixth means) generating the variable length frame only when the frame assembled at the first step (means) corresponds to the nonstandard frame format.

Namely, in the present invention, even if the VPI or the VCI corresponds to either method of the standard frame format or the nonstandard frame format, it is always made possible to receive the VPI or the VCI of both methods on the receiving side of the ATM cell.
[10] The above-mentioned [9] may include a step of (means) generating an alarm signal when it is determined that the frame does not correspond to the standard frame format at the fourth step (fifth means) and the frame does not correspond to the nonstandard frame format at the fifth step (sixth means).

Thus, when the ATM cell of the frame format different from the frame format statically or dynamically selected is received, an alarm can be generated for an operator or an operational screen.
[11] Also, the selection signal per VPI or VCI may be compulsorily set or released so as to correspond to the standard frame format or the nonstandard frame format.

Thus, when the frame of the frame format whose method is different from that of the preset frame format is received, process such as generating an alarm signal can be performed, so that it is made possible to perform a test as a system.
[12] Also, in another aspect of the present invention, the ATM cell or the standard frame format may be captured and displayed per frame. Thus, it is made possible to display the ATM cell captured for an operator, on an operational screen, or the like.
[13] The above-mentioned variable length frame may comprise an Ethernet frame, and the standard frame format of the predetermined specification may use a standard AAL5 frame format prescribed by RFC 1483 or RFC 2684.
[14] The above-mentioned header information deleted may include FCS information.

As shown in FIG. 2, FCS information (4 bytes) attached to the Ethernet frame FR_{E} is deleted, so that a nonstandard AAL5 frame FR₂₂ is generated. Even if the FCS information attached to the Ethernet frame FR_{E} is deleted therefrom to be transmitted to the ATM transmission line, the ATM cells may be re-assembled into the Ethernet frame by the receiving side device, and then the FCS information of the Ethernet frame from MAC DA to the payload may be re-calculated, so that the information may be attached again. By deleting the FCS information, it is made possible to further improve the transmission efficiency of the Ethernet frame on the ATM transmission line.

Also, there is a question that by deleting the FCS information, an error is not detected upon Ethernet frame transfer in an ATM network and reliability of the network is reduced. However, it does not matter since an error detecting CRC is attached to the AAL5 frame including the Ethernet frame.
[15] The above-mentioned nonstandard frame format may use BIP 8 or BIP 16 as error detection information.

Namely, as shown in FIG. 3, not by using the CRC (4 bytes) in the nonstandard frame format as shown in FIGS. 1A, 1B, and 2, but by a frame FR_{A3} of the nonstandard frame format using BIP (Bit Interleaved Parity) 8 (1 byte), BIP 16 (2 bytes), or the like using BIP information, information field for error detection can be made smaller than 4 bytes, thereby reducing additional information of the standard frame and realizing an improvement of a transmission efficiency.

As described above, by the network relay method and device according to the present invention, both of the nonstandard unique AAL5 frame format having reduced additional information of the AAL5 frame from the standard AAL5 frame format prescribed by the RFC 1483 and RFC 2684 as much as possible and the standard AAL5 frame format are mounted, and a mounting state of the AAL5 frame format of an opposed device is statically or dynamically determined, thereby enabling the transmission efficiency to be improved in the Ethernet Over ATM network, which extremely contributes to an optimum Ethernet Over ATM network operation.

### BRIEF DESCRIPTION OF THE DRAWINGS

The above and other objects and advantages of the invention will be apparent upon consideration of the following detailed description, taken in conjunction with the accompanying drawings, in which the reference numerals refer to like parts throughout and in which:

FIGS. 1A and 1B are diagrams of a frame format showing a principle [1] of a network relay method and device according to the present invention;

FIG. 2 is a diagram of a frame format showing a principle [2] of a network relay method and device according to the present invention;

FIG. 3 is a diagram of a frame format showing a principle [3] of a network relay method and device according to the present invention;

FIG. 4 is a block diagram showing a transmission system including a relay device to which the present invention is applied;

FIG. 5 is a block diagram showing an embodiment (1) of an Ethernet/ATM transmitter as a network relay device used for the present invention;

FIG. 6 is a block diagram showing an embodiment (1) of an ATM/Ethernet receiver as a network relay device used for the present invention;

FIG. 7 is a block diagram showing an embodiment (2) of an Ethernet/ATM transmitter as a network relay device used for the present invention;

FIG. 8 is a block diagram showing an embodiment (2) of an ATM/Ethernet receiver as a network relay device used for the present invention;

FIG. 9 is a block diagram showing an embodiment (3) of an Ethernet/ATM transmitter as a network relay device used for the present invention;

FIG. 10 is a diagram showing a relationship between VPI (VCI) and a transmission line (VLAN ID) in the transmission system shown in FIG. 4;

FIG. 11 is a block diagram showing an embodiment (3) of an ATM/Ethernet receiver as a network relay device used for the present invention;

FIG. 12 is a block diagram showing an embodiment (4) of an Ethernet/ATM transmitter as a network relay device used for the present invention;

FIG. 13 is a block diagram showing an embodiment (4) of an ATM/Ethernet receiver as a network relay device used for the present invention;

FIG. 14 is a block diagram showing an embodiment (5) of an Ethernet/ATM transmitter as a network relay device used for the present invention;

FIG. 15 is a block diagram showing an embodiment (5) of an ATM/Ethernet receiver as a network relay device used for the present invention;

FIG. 16 is a block diagram showing an embodiment (6) of an Ethernet/ATM transmitter as a network relay device used for the present invention;

FIG. 17 is a block diagram showing an embodiment (6) of an ATM/Ethernet receiver as a network relay device used for the present invention;

FIG. 18 is a block diagram showing an embodiment (7) of an Ethernet/ATM transmitter as a network relay device used for the present invention;

FIG. 19 is a format diagram of an OAM cell used for the network relay method and device according to the present invention;

FIG. 20 is a block diagram showing an embodiment (7) of an ATM/Ethernet receiver as a network relay device used for the present invention;

FIG. 21 is a block diagram showing an embodiment (8) of an Ethernet/ATM transmitter as a network relay device used for the present invention;

FIG. 22 is a block diagram showing an embodiment (8) of an ATM/Ethernet receiver as a network relay device used for the present invention;

FIG. 23 is a block diagram showing an embodiment (9) of an ATM/Ethernet receiver as a network relay device used for the present invention;

FIG. 24 is a block diagram showing an embodiment (10) of an ATM/Ethernet receiver as a network relay device used for the present invention;

FIG. 25 is a block diagram showing an embodiment (11) of an ATM/Ethernet receiver as a network relay device used for the present invention;

FIGS. 26A and 26B are diagrams showing a modification of a management table used for a network relay method and device according to the present invention;

FIG. 27 is block diagram showing an embodiment (12) of an ATM/Ethernet receiver as a network relay device used for the present invention; and

FIGS. 28A and 28B are diagrams showing a frame format describing a prior art network relay method.

### DESCRIPTION OF THE EMBODIMENTS

### Network System Example to Which the Present Invention is Applied

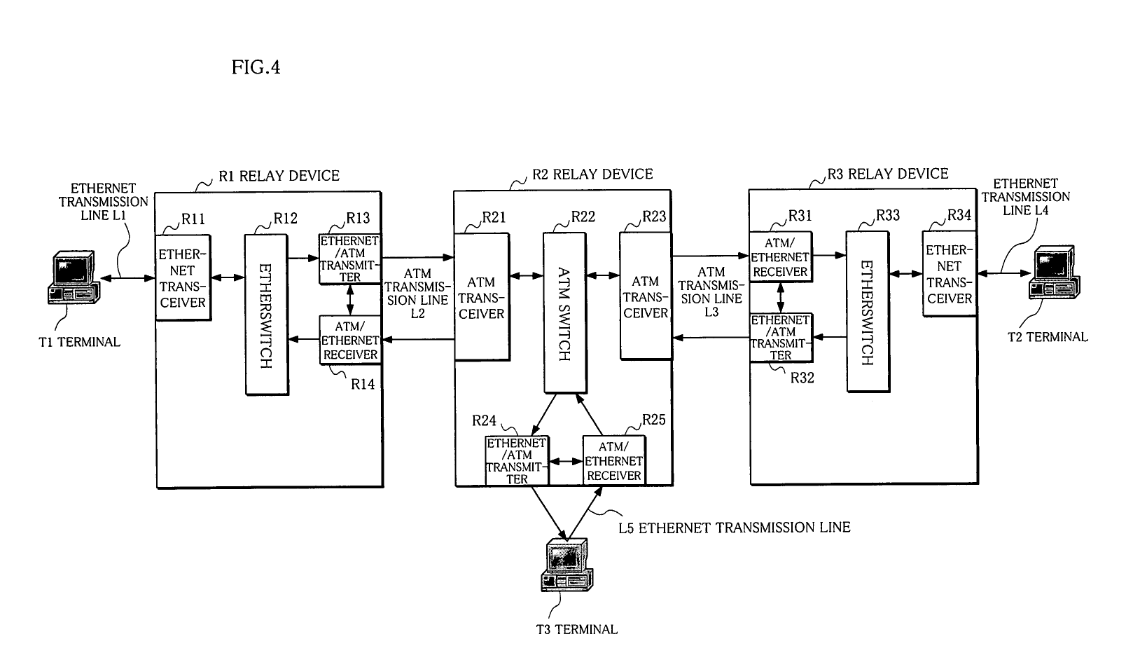

FIG. 4 shows a network system to which the network relay method and device according to the present invention are applied. In this example, terminals T1-T3 are connected to relay devices R1-R3. The relay device R1 and the terminal T1 are mutually connected with an Ethernet transmission line L1, the relay devices R1 and R2 are mutually connected with an ATM transmission line L2, the relay devices R2 and R3 are mutually connected with an ATM transmission line L3, the terminal T2 and the relay device R3 are mutually connected with an Ethernet transmission line L4, and the terminal T3 and the relay device R2 are mutually connected with an Ethernet transmission line L5.

Accordingly, the relay device R1, as shown, is composed of an Ethernet transceiver R11 connected to the Ethernet transmission line L1, an EtherSwitch R12 having an EtherSwitch function, an Ethernet/ATM transmitter R13, and an ATM/Ethernet receiver R14, the transmitter R13 and the receiver R14 being both connected to the ATM transmission line L2. Similarly, the relay device R3 is composed of an ATM/Ethernet receiver R31, an Ethernet/ATM transmitter R32, the receiver R31 and the transmitter R32 being both connected to the ATM transmission line L3, an EtherSwitch R33, and an Ethernet transceiver R34 connected to the ATM transmission line L4. Furthermore, the relay device R2 is composed of an ATM transceiver R21 connected to the ATM transmission line L2, an ATM switch R22 having an ATM cell switch function, an ATM transceiver R23 connected to the ATM transmission line L3, an Ethernet/ATM transmitter R24, and an ATM/Ethernet receiver R25, the transmitter R24 and the receiver R25 being both connected to the Ethernet transmission line L5.

In such a system, the network relay method and device according to the present invention is realized by the Ethernet/ATM transmitters R13 and R32, the ATM/Ethernet receivers R14 and R31, the Ethernet/ATM transmitter R24, and the ATM/Ethernet receiver R25. Respective embodiments thereof will now be described referring to the attached figures.

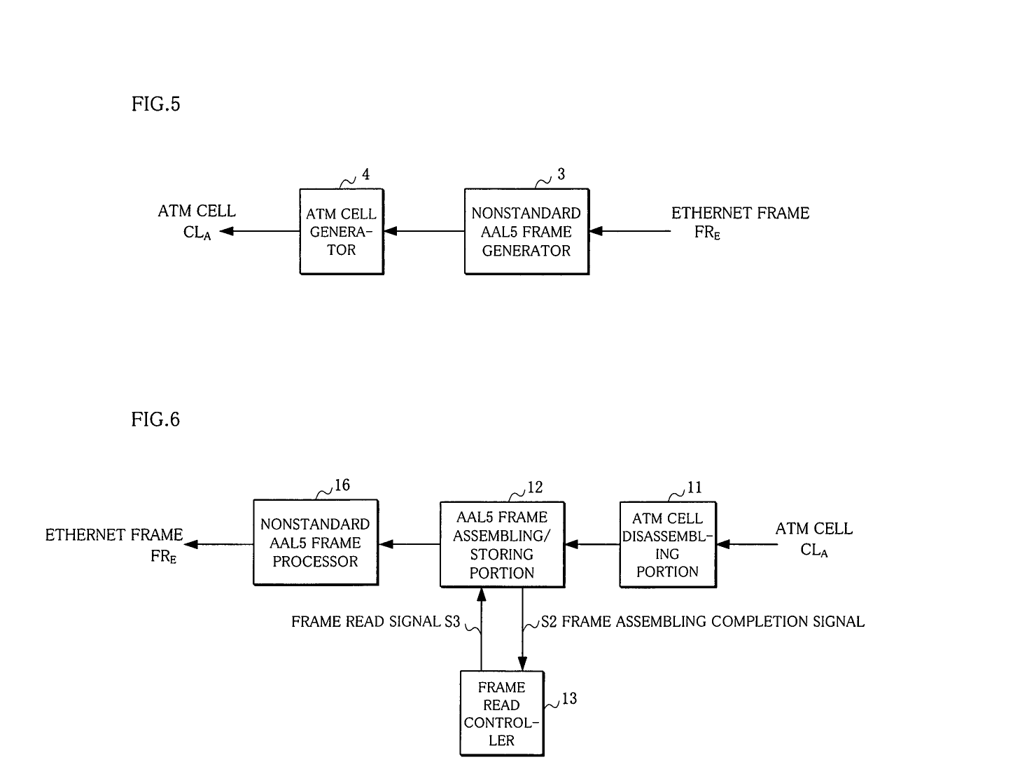

### Embodiment (1) of Ethernet/ATM Transmitter: FIG. 5

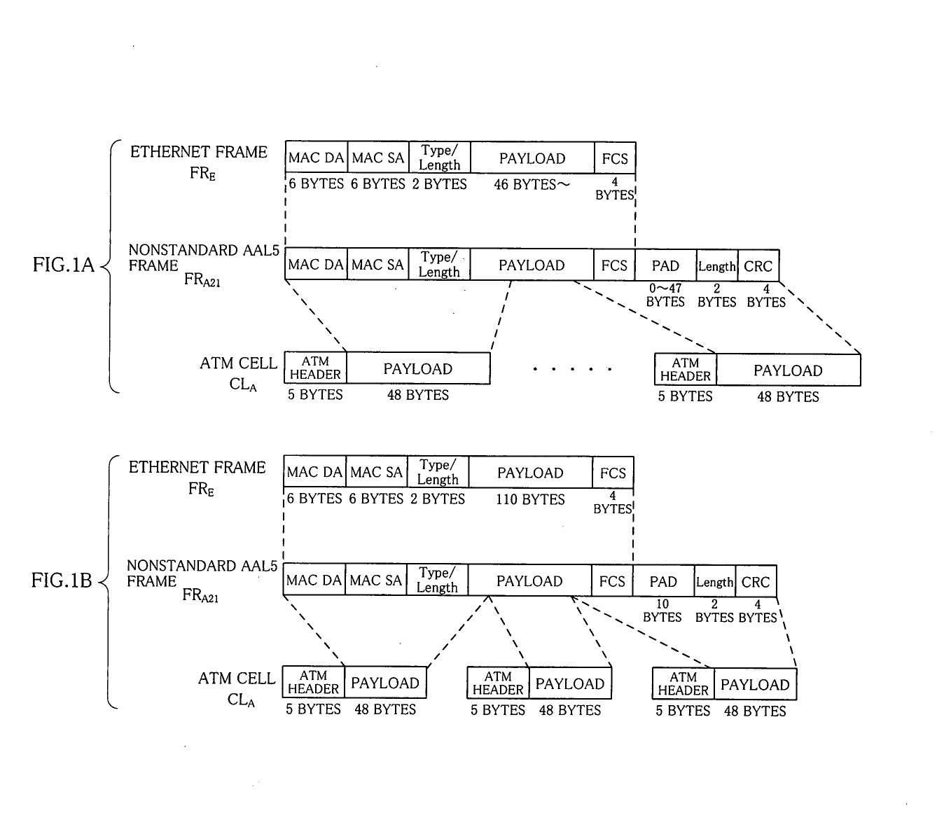

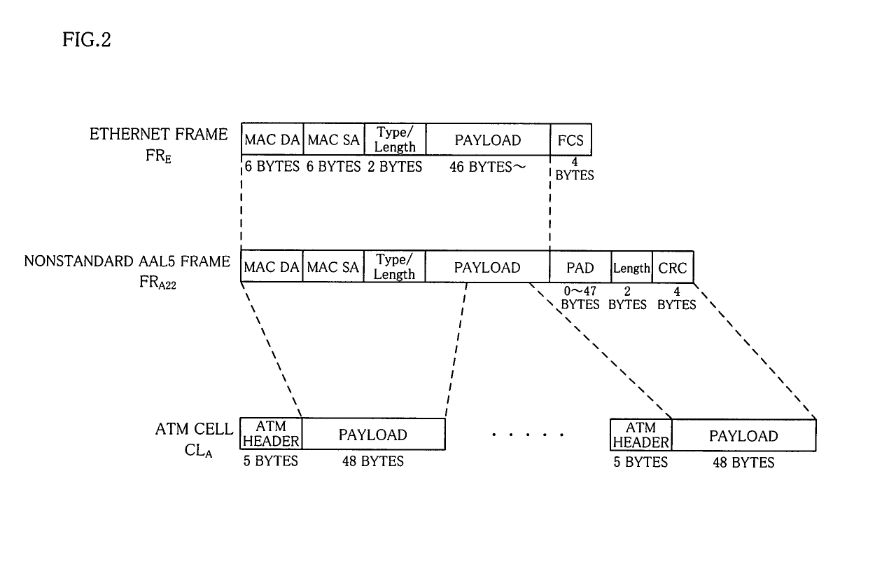

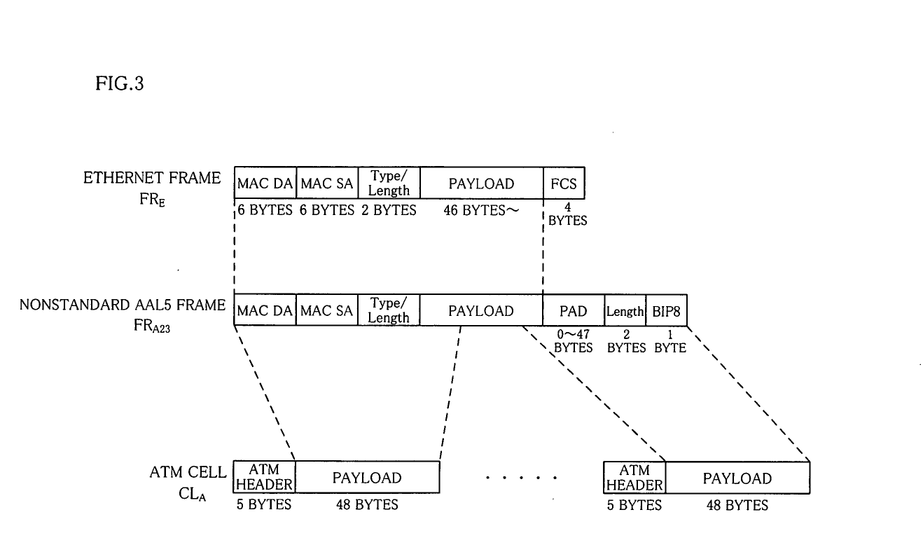

This embodiment shows a case where it is predetermined that the ATM cell CL_{A} is generated from the nonstandard AAL5 frame FR_{A21} that is the Ethernet frame FR_{E} capsuled as shown in FIGS. 1A and 1B, when the Ethernet/ATM transmitter of this case generates the ATM cell from the Ethernet frame transmitted from the above-mentioned Ethernet transmission lines L1, L4, and L5. It is to be noted that in the following description both of the standard AAL5 frame and the nonstandard AAL5 frame may be occasionally generally referred to as “AAL5 frame”.

Therefore, the Ethernet frame FR_{E} is, as shown in FIG. 5, capsuled into the nonstandard AAL5 frame FR_{A21} as shown in FIGS. 1A and 1B by a nonstandard AAL5 frame generator 3, and is further converted into ATM cells CL_{A} each of which is formed of 53 bytes by an ATM cell generator 4 to be transmitted to the above-mentioned ATM transmission lines L2 and L3.

### Embodiment (1) of ATM/Ethernet Receiver: FIG. 6

This ATM/Ethernet receiver corresponds to the Ethernet/ATM transmitter shown in FIG. 5, and is based on the premise that the ATM cells of this case are generated from the frame of the nonstandard AAL5 frame format.

Therefore, as shown in FIG. 6, when an ATM cell disassembling portion 11 receives a plurality of ATM cells CL_{A} generated by the ATM cell generator 4 of the Ethernet/ATM transmitter shown in FIG. 5, the ATM cells CL_{A} are disassembled into header information and payload information to be transmitted to an AAL5 frame assembling/storing portion 12. The AAL5 frame assembling/storing portion 12 stores the payload information in an internal frame assembling queue concerned (not shown), from the received header information.

In each frame assembling queue, a frame assembling completion signal S2 is transmitted to a frame read controller 13 upon assembling completion of the AAL5 frame. The frame read controller 13 having received this frame assembling completion signal S2 transmits a frame read signal S3 to the AAL5 frame assembling/storing portion 12, and the AAL5 frame assembling/storing portion 12 having received the frame read signal S3 reads the AAL5 frame concerned, from the frame assembling queue to be provided to a nonstandard AAL5 frame processor 16.

The nonstandard AAL5 frame processor 16 performs a CRC check of the received AAL5 frame, and transmits the Ethernet frame FR_{E} from which additional information including a PAD portion is deleted to the Ethernet transmission line based on Length information.

Thus, when an Ethernet Over ATM network is constructed only by a relay device which can deal with the nonstandard AAL5 frame format, in the embodiment (1) of the ATM/Ethernet receiver of FIG. 6 having received from the ATM transmission line the ATM cells CLA generated by the nonstandard AAL5 frame generator 3 and the ATM cell generator 4 in the embodiment (1) of the Ethernet/ATM transmitter shown in FIG. 5, the ATM cells CL_{A} are converted into the nonstandard AAL5 frame, thereby enabling the ATM cells to be returned to the Ethernet frame FR_{E}.

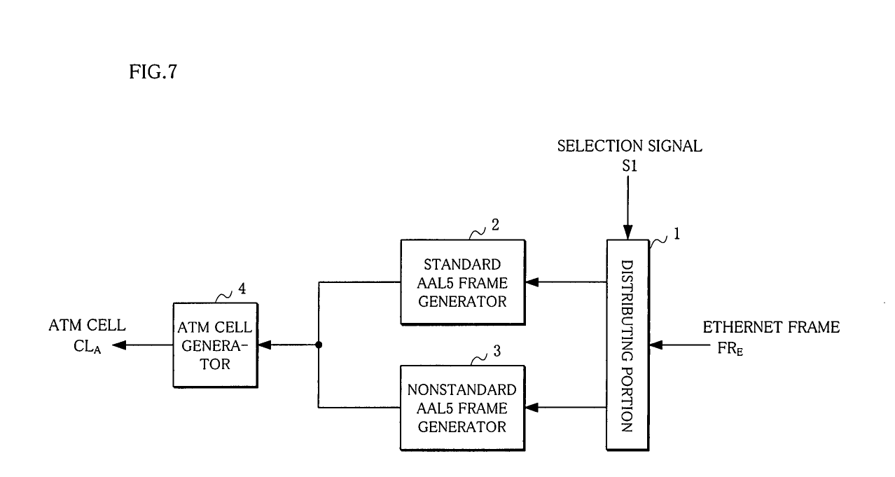

### Embodiment (2) of Ethernet/ATM Transmitter: FIG. 7

In order to attend to both of the well known ATM cellulating method using the standard AAL5 frame format prescribed by the RFC 1483 and the RFC 2684 and of the ATM cellulating method by the present invention using the nonstandard AAL5 frame format as shown in FIGS. 1A and 1B, this Ethernet/ATM transmitter enables the ATM cellulating method to be statically selected per relay device (example in FIG. 4).

In this embodiment, the Ethernet/ATM transmitter is composed of a distributing portion 1 for inputting the Ethernet frame FR_{E} and a selection signal S1, a standard AAL5 frame generator 2 and a nonstandard AAL5 frame generator 3 both connected to the distributing portion 1, and an ATM cell generator 4 generating the ATM cells CL_{A} commonly connected to the frame generators 2 and 3.

In operation, the distributing portion 1 exclusively distributes the Ethernet frame FR_{E} received to the standard AAL5 frame generator 2 or the nonstandard AAL5 frame generator 3 based on the selection signal S1. The standard AAL5 frame generator 2 capsules the received Ethernet frame FR_{E} by the standard AAL5 frame format to be transmitted to the ATM cell generator 4. The nonstandard AAL5 frame generator 3 capsules the Ethernet frame FR_{E} received by the nonstandard AAL5 frame format to be transmitted to the ATM cell generator 4.

The selection signal S1 of this case is a signal in which either the AAL5 frame format of the standard frame format or the nonstandard frame format should be selected is preset per relay device.

The ATM cell generator 4 divides the AAL5 frame received from the frame generator 2 or 3 into 48-byte payloads, generates a plurality of fixed length ATM cells CL_{A} to which 5-byte ATM headers are attached, and then transmits the ATM cells CL_{A} to the ATM transmission line.

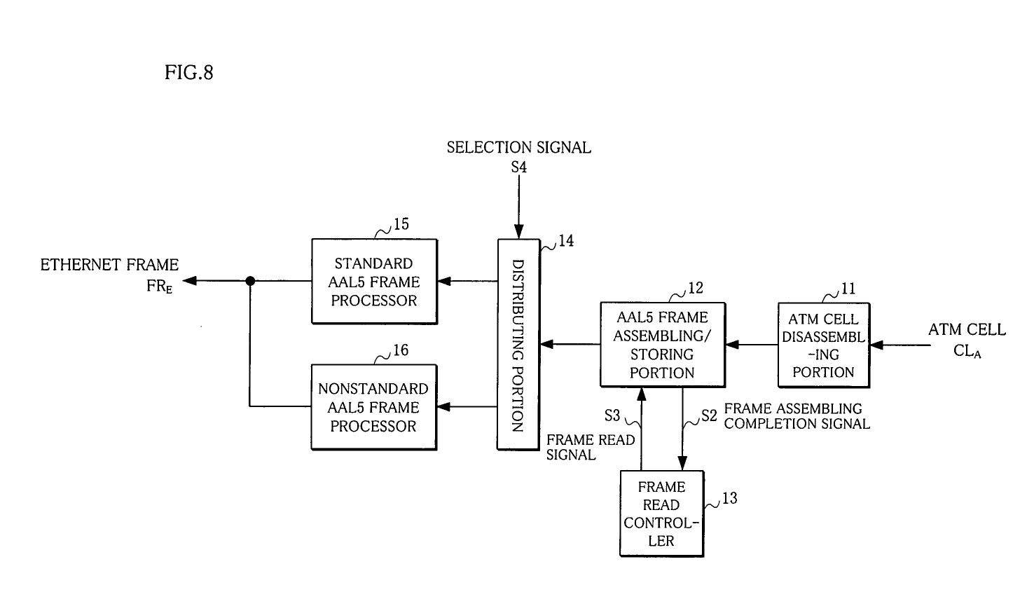

### Embodiment (2) of ATM/Ethernet Receiver: FIG. 8

The ATM/Ethernet receiver corresponds to the Ethernet/ATM transmitter shown in FIG. 7. Therefore, the ATM/Ethernet receiver is composed of the ATM cell disassembling portion 11 for receiving the ATM cells CLA, the AAL5 frame assembling/storing portion 12 connected to the ATM cell disassembling portion 11, the frame read controller 13 for transmitting and receiving the frame assembling completion signal S2 and the frame read signal S3 with the AAL5 frame assembling/storing portion 12, a distributing portion 14 connected to the AAL5 frame assembling/storing portion 12 to input a selection signal S4, a standard AAL5 frame processor 15, and the nonstandard AAL5 frame processor 16, the processor 15 and the processor 16 being both connected to the distributing portion 14. The outputs of the frame processors 15 and 16 are commonly connected to output the Ethernet frame FR_{E} to the Ethernet transmission line.

In operation, the ATM cell disassembling portion 11 firstly disassembles the received ATM cells CL_{A} into the header information and the payload information to be transmitted to the AAL5 frame assembling/storing portion 12. At that time, the ATM cell disassembling portion 11 need not recognize whether the ATM cells CL_{A} have been generated from the standard frame format or the nonstandard frame format.

As mentioned above, the AAL5 frame assembling/storing portion 12 stores the payload information in the internal frame assembling queue concerned (not shown) from the received header information. At each frame assembling queue, the frame assembling completion signal S2 is transmitted to the frame read controller 13 upon assembling completion of the AAL5 frame. The frame read controller 13 having received the signal S2 transmits the frame read signal S3 to the AAL5 frame assembling/storing portion 12. The AAL5 frame assembling/storing portion 12 having received the frame read signal S3 reads the AAL5 frame concerned to be transmitted to the distributing portion 14.

The selection signal S4 in which either the AAL5 frame of the standard or the nonstandard should be selected is set per relay device is provided to the distributing portion 14, and the distributing portion 14 exclusively distributes the AAL5 frame received from the AAL5 frame assembling/storing portion 12 to the standard AAL5 frame processor 15 or the nonstandard AAL5 frame processor 16 based on the selection signal S4.

Accordingly, the standard AAL5 frame processor 15 or the nonstandard AAL5 frame processor 16 performs the CRC check of the received AAL5 frame, and transmits the Ethernet frame FR_{E} from which the additional information including the PAD portion is deleted based on the Length information to the Ethernet transmission line.

Thus, by the embodiment (2) shown in FIGS. 7 and 8, a selection control of the standard AAL5 frame format or the nonstandard AAL5 frame format per relay device is made possible. Therefore, when the Ethernet Over ATM network is constructed only with the relay device which can generate the nonstandard AAL5 frame format, the selection signals S1 and S4 may be set so as to select the nonstandard AAL5 frame format, for improving the transmission efficiency. Also, when the relay devices are arranged in the Ethernet Over ATM network requesting the connection with the relay devices which can generate only the standard AAL5 frame format, the selection signals S1 and S4 may be set so as to select the standard AAL5 frame format, thereby enabling an optimum Ethernet Over ATM network to be constructed by using devices mounting the present invention.

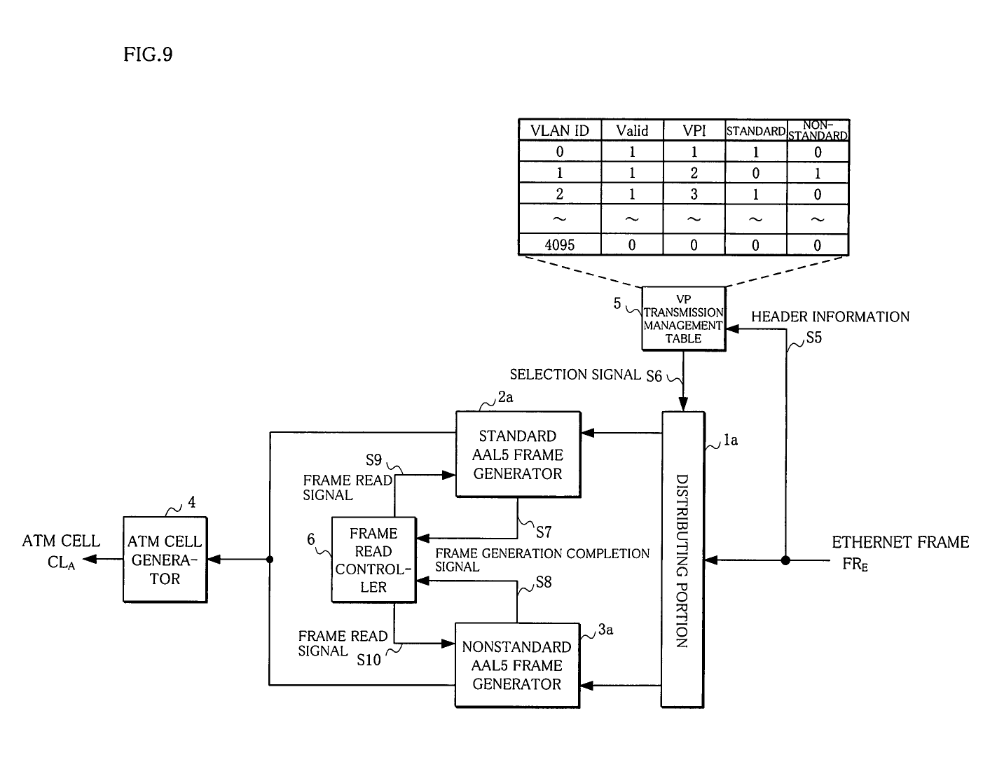

### Embodiment (3) of Ethernet/ATM Transmitter: FIG. 9

In the case of this Ethernet/ATM transmitter, the AAL5 frame format is selected per VP (Virtual Path) connection, different from the embodiment (2) of FIG. 7 in which the AAL5 frame format is selected per relay device.

Therefore, in the embodiment (3) a VP transmission management table 5 is provided in addition to the embodiment (2) of FIG. 7. This VP transmission management table 5 has the following information with VLAN ID as an index, where while an index is made VLAN ID in this embodiment, a MAC address and other information may be made an index:
Valid indicates whether the concerned table is valid or invalid, where “0” means invalid and “1” means valid.
VPI stores a VPI value corresponding to the concerned VLAN ID frame.
Standard/nonstandard indicates whether the standard AAL5 frame or the nonstandard AAL5 frame is selected, where “0” is set for “non-selected”, and “1” is set for “selected”. Also, the standard/nonstandard is exclusively set, and “1” is never set to the both of the frames at the same time.

In operation, header information S5 such as VLAN ID is extracted from the Ethernet frame FR_{E} inputted and then the header information S5 is provided to the VP transmission management table 5. The VP transmission management table 5 determines the AAL5 frame format based on whether “1” is set in the standard field or “1” is set in the nonstandard field, with the header information S5 as an index, and then transmits its determination result to a distributing portion 1a as a selection signal S6.

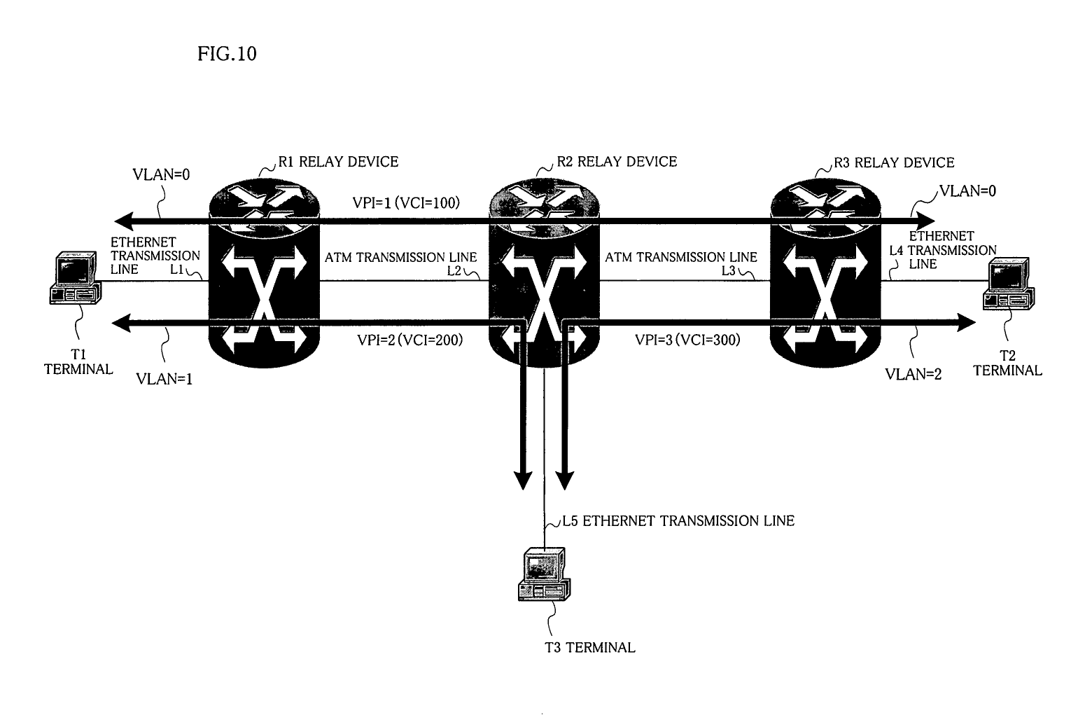

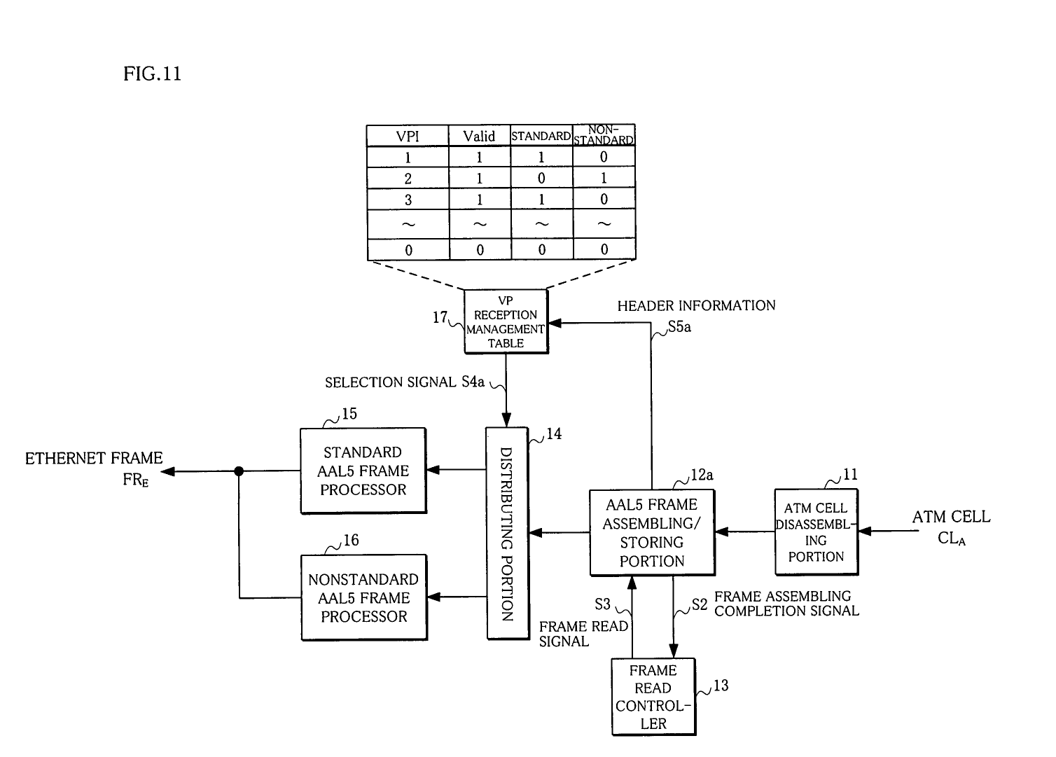

The network system shown in FIG. 4 associated with VP connections (VPI) is shown in FIG. 10. Namely, VLAN=0 connecting the terminals T1 and T2 is associated with the VPI=1. The VPI=2 is assigned to the VLAN=1 between the terminals T1 and T3, and the VPI=3 is assigned to the VLAN=2 between the terminals T2 and T3. Although the VLAN ID corresponds to the VPI one-on-one in this case, the Ethernet frame includes only the VLAN ID. Therefore, in the VP transmission management table 5, the frame format is determined with the VLAN ID in the header information S5 as an index.

The distributing portion 1a exclusively distributes the inputted Ethernet frame FR_{E} to a standard AAL5 frame generator 2a or a nonstandard frame generator 3a by the received selection signal S6.

The frame generator 2a or 3a capsules the received Ethernet frame FR_{E} into the AAL5 frame. After generating the AAL5 frame, the frame generator 2a or 3a notifies a frame completion signal S7 or S8 to a frame read controller 6. When receiving the frame generation completion signal S7 or S8, the frame read controller 6 controls so that the AAL5 frame read from the standard AAL5 frame generator 2a and the AAL5 frame read from the nonstandard AAL5 frame generator 3a may not mutually conflict in their timings, and transmits an AAL5 frame read signal S9 or S10 to the frame generator 2a or 3a. The frame read control is performed since the header information S5 is constantly extracted from the Ethernet frame FR_{E}, different from the embodiment (2) of FIG. 7, and the selection signal S6 is generated by referring to the table 5. Therefore, the output frames of the frame generators 2a and 3a may mutually conflict.

Thus, the ATM cell generator 4 having received the AAL5 frame transmitted from the frame generator 2a or 3a generates the ATM cells CL_{A} to be transmitted to the ATM transmission line.

### Embodiment (3) of ATM/Ethernet Receiver: FIG. 11

In the case of this ATM/Ethernet receiver, a VP reception management table 17 is provided, different from the embodiment (2) of the ATM/Ethernet receiver shown in FIG. 8. This VP reception management table 17 is for managing the header information of the ATM cells and the VP connection, and is statically set from PVC (Permanent Virtual Connection) information upon network setup. This table 17 has the following information with the VPI included in header information S5a of the received ATM cells CL_{A} as an index:
Valid indicates whether the concerned table information is valid or invalid, where “0” means invalid, and “1” means valid.
Standard/nonstandard indicates whether the standard AAL5 frame or the nonstandard AAL5 frame is selected, where “0” means “non-selected”, and “1” means “selected”. The standard/nonstandard is exclusively set, and “1” is never set simultaneously for both of the frames.

In operation of this embodiment, the ATM cell disassembling portion 11 disassembles the received ATM cells CL_{A} into the header information and the payload information to be transmitted to an AAL5 frame assembling/storing portion 12a. The AAL5 frame assembling/storing 12a transmits the VPI of the ATM cell header received from the ATM cell disassembling portion 11 to the VP reception management table 17 as the header information S5a of the AAL5 frame concerned upon transmission of the AAL5 frame after the completion of the AAL5 frame assembling.

The VP reception management table 17 determines the AAL5 frame format concerned by referring to the table with the VPI of the header information S5a as an index, and provides a selection signal S4a to the distributing portion 14.

The distributing portion 14 exclusively distributes the AAL5 frames from the AAL5 frame assembling/storing portion 12a according to the selection signal S4a, so that the frame processors 15 and 16 respectively delete the additional information and transmit the Ethernet frame FR_{E} to the Ethernet transmission line.

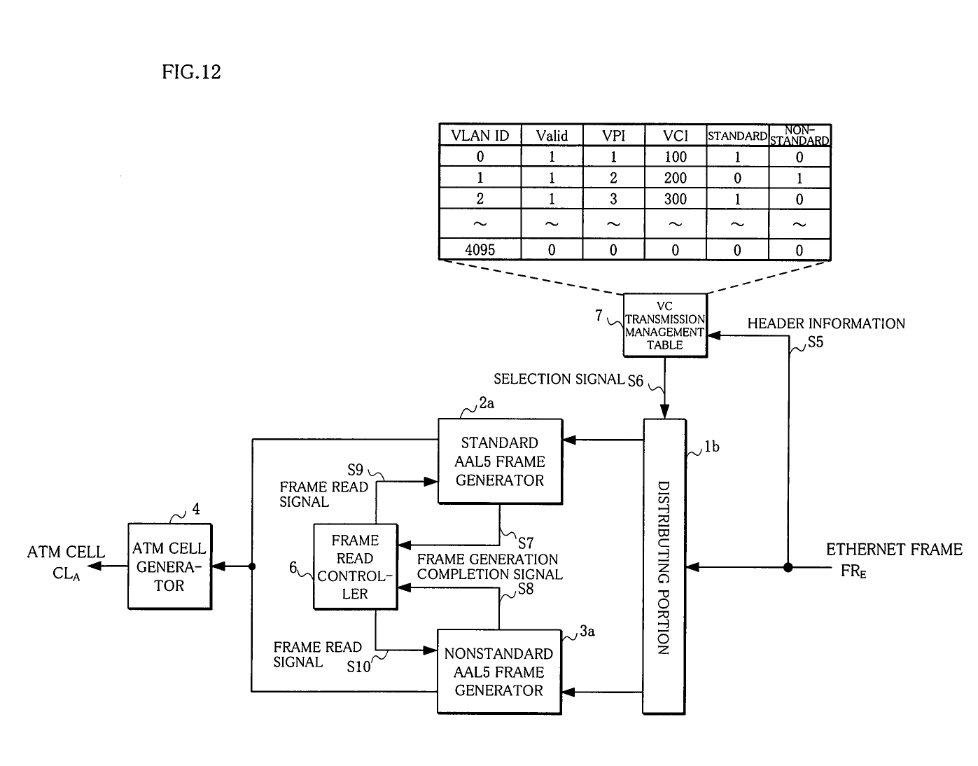

### Embodiment (4) of Ethernet/ATM Transmitter: FIG. 12

In the case of the Ethernet/ATM transmitter, a VC transmission management table 7 is substituted for the VP transmission management table 5 different from the embodiment (3) shown in FIG. 9. By providing the VC transmission management table 7, the selection of the AAL5 frame format per VC connection is enabled. In the VC transmission management table 7, it is required to refer to the table with not only the VPI but also both of the VPI and the VCI as an index, different from the case of the VP transmission management table 5.

Namely, FIG. 10 shows a relationship between not only the VPI and the transmission line, but also the VCI and the transmission line. For example, the selection of the nonstandard frame format is indicated when the VIAN ID=0, Valid=1, VPI=1, and VCI=100.

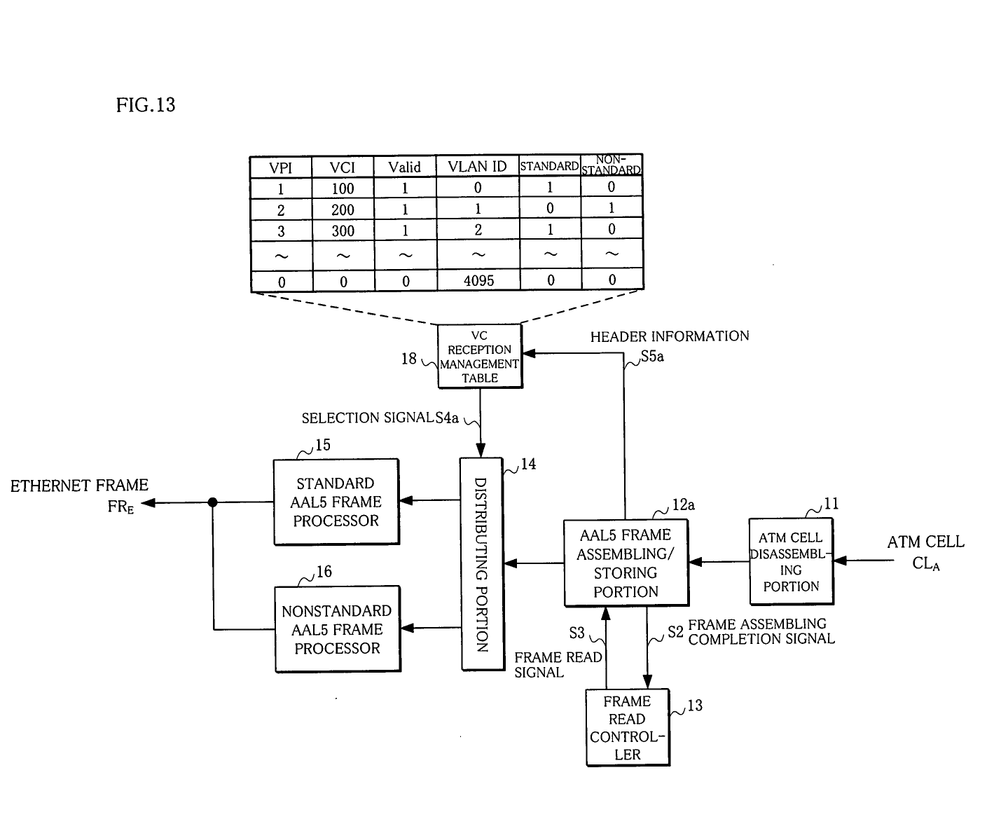

### Embodiment (4) of ATM/Ethernet Receiver: FIG. 13

This ATM/Ethernet receiver corresponds to the embodiment (4) shown in FIG. 12, and substitutes a VC reception management table 18 for the VP reception management table 17 in the embodiment (3) shown in FIG. 11. Therefore, in this VC reception management table 18, it is required to refer to the table with not only the VPI but also both of the VPI and the VPI as the index of the table in the same way as the case of the VC transmission management table 7 shown in FIG. 12.

It is to be noted that a connection management table including both of a VP management table and a VC management table is allowed to be used in the present invention.

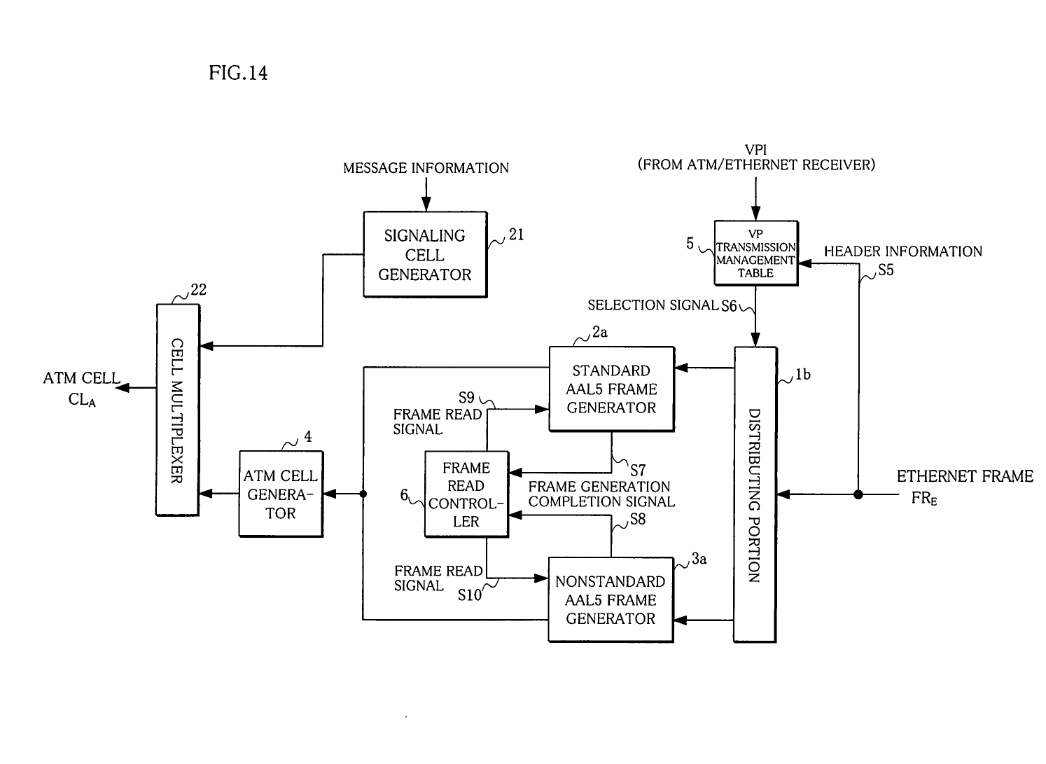

### Embodiment (5) of Ethernet/ATM Transmitter: FIG. 14

While the above-mentioned embodiments adopt a method of either presetting a selection signal per relay device or presetting the selection signal in the management table, in the embodiment (5) an inquiry about the AAL5 frame format is performed by using a signaling cell upon call establishment of the VP connection by an SVC (Switched Virtual Connection) for the opposed relay device, in order to dynamically set the management table.

The signaling cell is a control signal cell having a value of the VCI=5. When the AAL5 frame format is inquired by using the signaling cell, and when the opposed relay device does not attend to the nonstandard AAL5 frame format, no response is provided to the inquiry. Therefore, the AAL5 frame format of the VP connection is determined to be the standard AAL5 frame format. Also, when the opposed relay device mounts thereon the nonstandard AAL5 frame format, the response for the signaling cell is provided. Therefore, it is determined that the relay device mounts thereon the nonstandard AAL5 frame format, and that the AAL5 frame format of the concerned VP connection is the nonstandard AAL5 frame format.

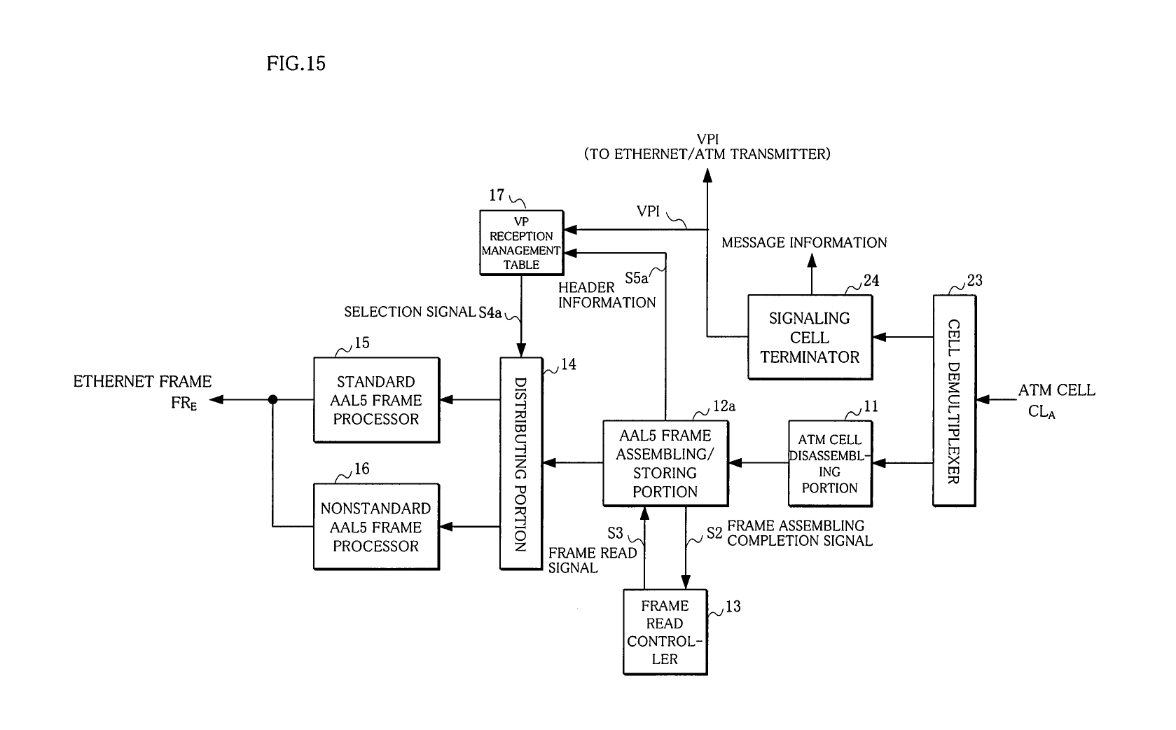

Therefore, in the embodiment (5) of the Ethernet/ATM transmitter, different from the embodiment (3) shown in FIG. 9 for example, a signaling cell generator 21 is provided, where cell multiplexing is performed to the ATM cell from the ATM cell generator 4 and at a cell multiplexer 22. Also, when the signaling cell generated from the opposed relay device in response to the reception of the signaling cell is received by the ATM cell/Ethernet receiver (see FIG. 15), the VP transmission management table 5 is updated based on the VPI included in the header information.

In operation, the signaling cell generator 21 generates the signaling cell upon receiving instructions from a processor (not shown). The signaling cell includes message information for call setting, and a message which can be communicated between the relay devices mounting thereon the nonstandard AAL5 frame format is included therein.

Accordingly, the signaling cell is transmitted from the cell multiplexer 22 of the Ethernet/ATM transmitter R13 in the relay device R1 shown in e.g. FIG. 4 mounting thereon the nonstandard AAL5 flame format to the ATM/Ethernet receiver R31 of the opposed relay device R3. It is to be noted that the cell multiplexer 22 separately performs multiplexing to the signaling cell from the system generator 21 and the ATM cell from the ATM cell generator 4.

Thus, the signaling cell transmitted from the Ethernet/ATM transmitter R13 is terminated at the opposed ATM/Ethernet receiver R31.

### Embodiment (5) of ATM/Ethernet Receiver: FIG. 15

This ATM/Ethernet receiver corresponds to the above-mentioned ATM/Ethernet receiver R31. A cell demultiplexer 23 and a signaling cell terminator 24 are provided corresponding to the signaling cell generator 21 and the cell multiplexer 22 provided in the Ethernet/ATM transmitter R13 shown in FIG. 14.

In the operation of the embodiment (5) of the Ethernet/ATM transmitter and the ATM/Ethernet receiver, the cell demultiplexer 23 firstly demultiplexes the received ATM cell CL_{A} into the signaling cell and a non-signaling cell, transmits the signaling cell to the signaling cell terminator 24, and transmits the non-signaling cell to the ATM cell disassembling portion 11. It is to be noted that the cell demultiplexer 23 can demultiplex the signaling cell by determining the VCI=5 in the header information in the received ATM cell CL_{A}.

The signaling cell transmitted to the signaling cell terminator 24 extracts message information integrated into the signaling cell by the signaling cell generator 21 in the opposed Ethernet/ATM transmitter R13 to be transferred to a processor (not shown). The signaling cell terminator 24 transmits the VPI extracted from the header information of the ATM cell to the ATM/Ethernet receiver R14 of the relay device R1 from the Ethernet/ATM transmitter R32, and sets in the VP reception management table 17 in combination with the VPI that the frame is the nonstandard frame format.

The Ethernet/ATM transmitter R32 in this case corresponds to the embodiment (5) of the Ethernet/ATM transmitter shown in FIG. 14. If the relay device R3 mounts thereon the nonstandard AAL5 frame format, the fact that the relay device mounts thereon the nonstandard AAL5 frame format is notified by generating the similar signaling cell from the signaling generator 21 for the inquiry from the relay device R1. Then, the Ethernet/ATM transmitter R32 sets in the VP transmission management table 5 that the frame is the nonstandard AAL5 frame format for the VPI corresponding to the opposed relay device R1.

Also, the ATM/Ethernet receiver R14 of the relay device R1 having received the signaling cell from the Ethernet/ATM transmitter R32 thus terminates the signaling cell by the signaling cell terminator 24, and transfers the message information within the signaling cell received to the processor (not shown). When it is found by the message information that the relay device R3 mounts thereon the nonstandard AAL5 frame format, the signaling cell terminator 24 sets in the VP reception management table 17 in combination with the VPI that the frame is the nonstandard AAL5 frame format.

Thus, by using the signaling information upon establishing VP connection, the mounting state of the AAL5 frame format of an opposed relay device is determined, thereby enabling dynamic setting of the AAL5 frame format.

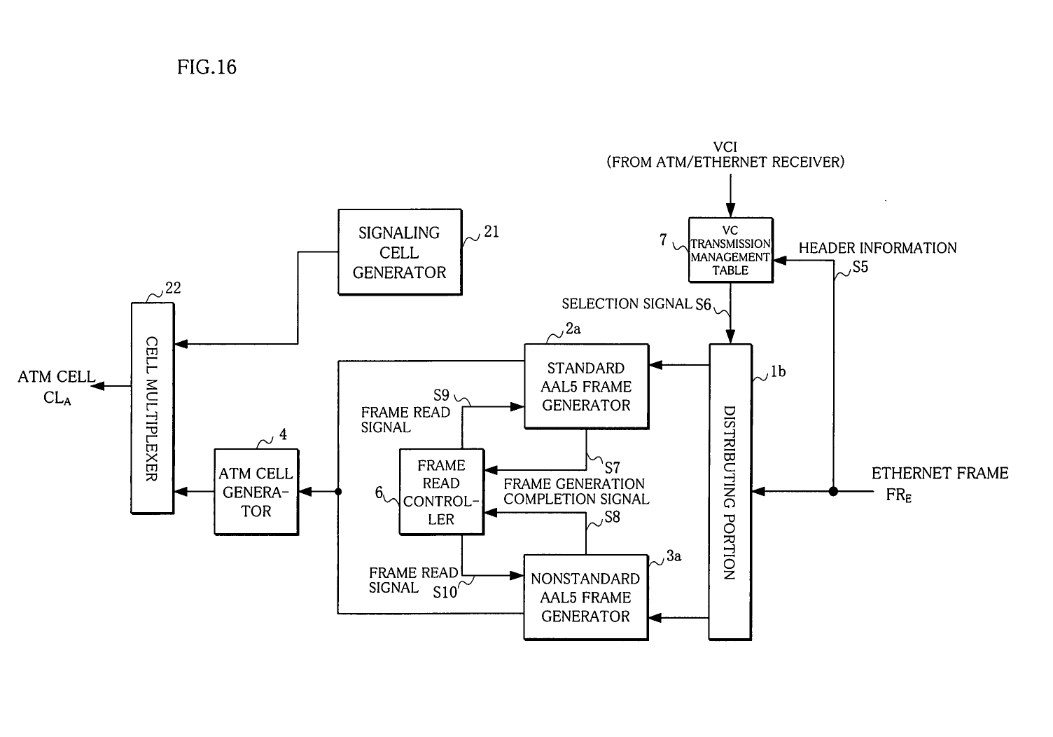

### Embodiment (6) of Ethernet/ATM Transmitter: FIG. 16

This Ethernet/ATM transmitter is different from the Ethernet/ATM transmitter shown in FIG. 14 of the embodiment (5) in that the VC transmission management table 7 is substituted for the VP transmission management table 5.

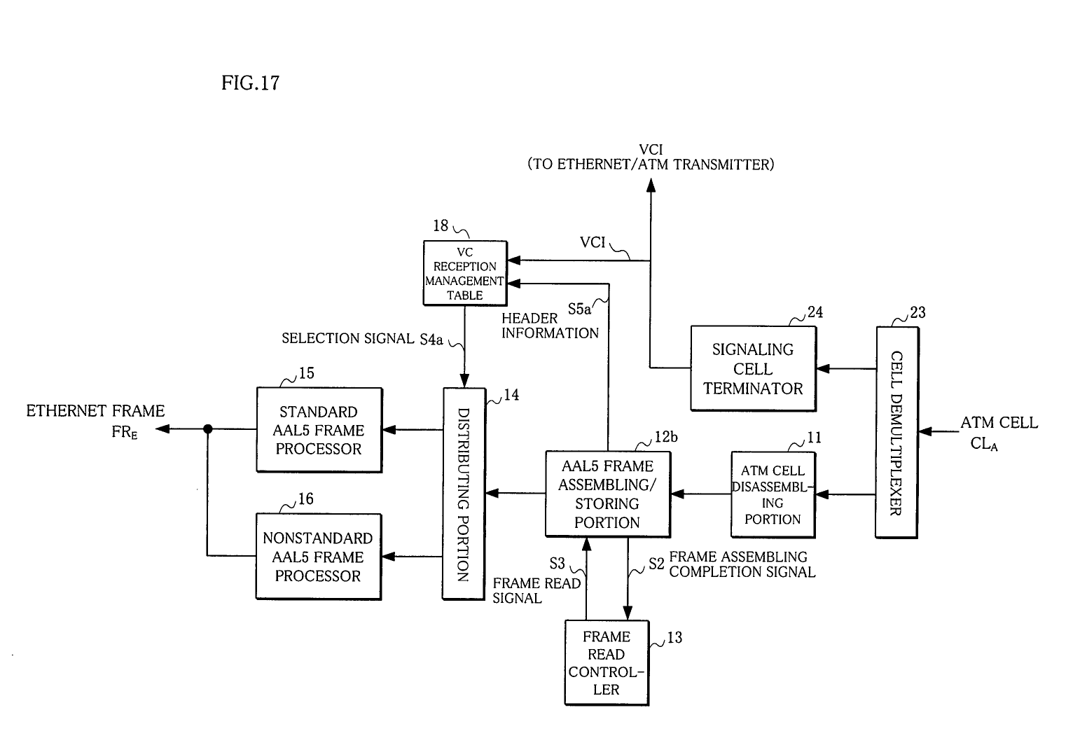

### Embodiment (6) of ATM/Ethernet Receiver: FIG. 17

The ATM/Ethernet receiver corresponds to the Ethernet/ATM transmitter shown in FIG. 16. Therefore, also in the ATM/Ethernet receiver of the embodiment (6) in the same way as the embodiment (6) of the Ethernet/ATM transmitter, the VC reception management table 18 is substituted for the VP reception management table 17, which is different from the embodiment (5) shown in FIG. 15.

By the embodiment (6), the inquiry about the AAL5 frame format is performed by using the signaling cell upon establishing the VC connection by the SVC. Namely, when the opposed relay device does not mount thereon the nonstandard AAL5 frame format, there is no response for the inquiry. Therefore, the concerned VC connection is determined to be the standard AAL5 frame format. Also, when the opposed relay device mounts thereon the nonstandard AAL5 frame format, the opposed relay device is determined to have mounted thereon the nonstandard AAL5 frame format by the response for the signaling cell, and the concerned VC connection is determined to be the standard AAL5 frame format to be set.

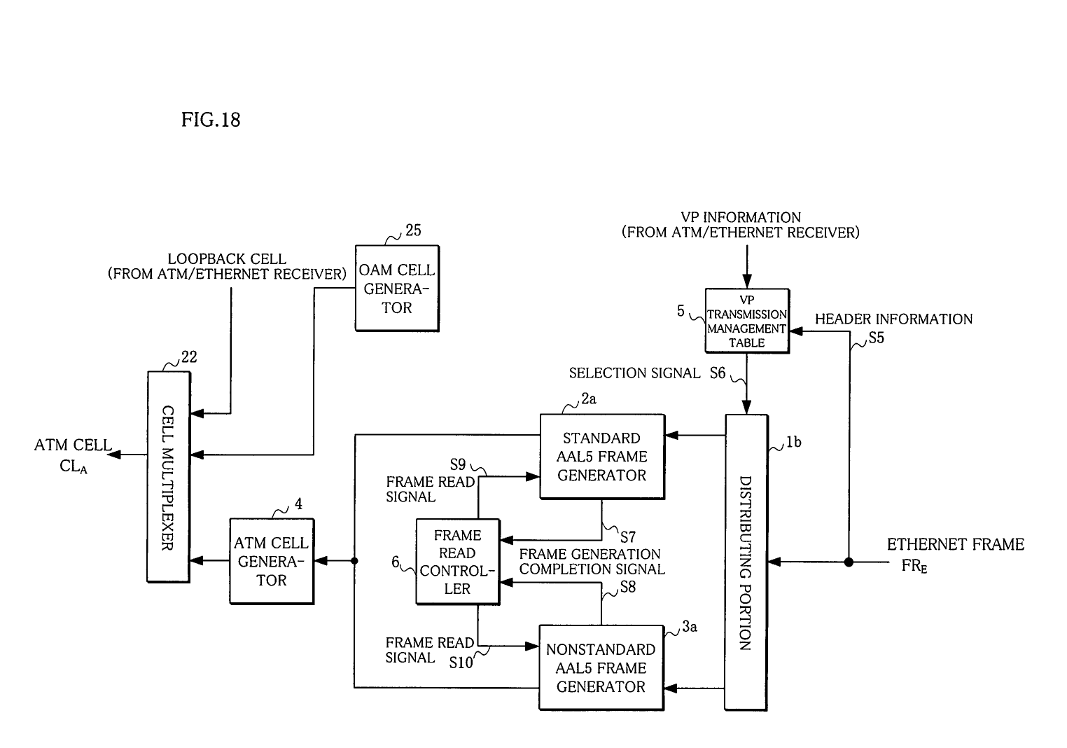

### Embodiment (7) of Ethernet/ATM Transmitter: FIG. 18

This Ethernet/ATM transmitter is different from the embodiment (5) shown in FIG. 14 in that an OAM generator 25 is provided instead of the signaling cell generator 21, and that the cell multiplexer 22 is arranged to multiplex not only the ATM cells from the OAM cell generator 25 and the ATM cell generator 4 but also loopback cells.

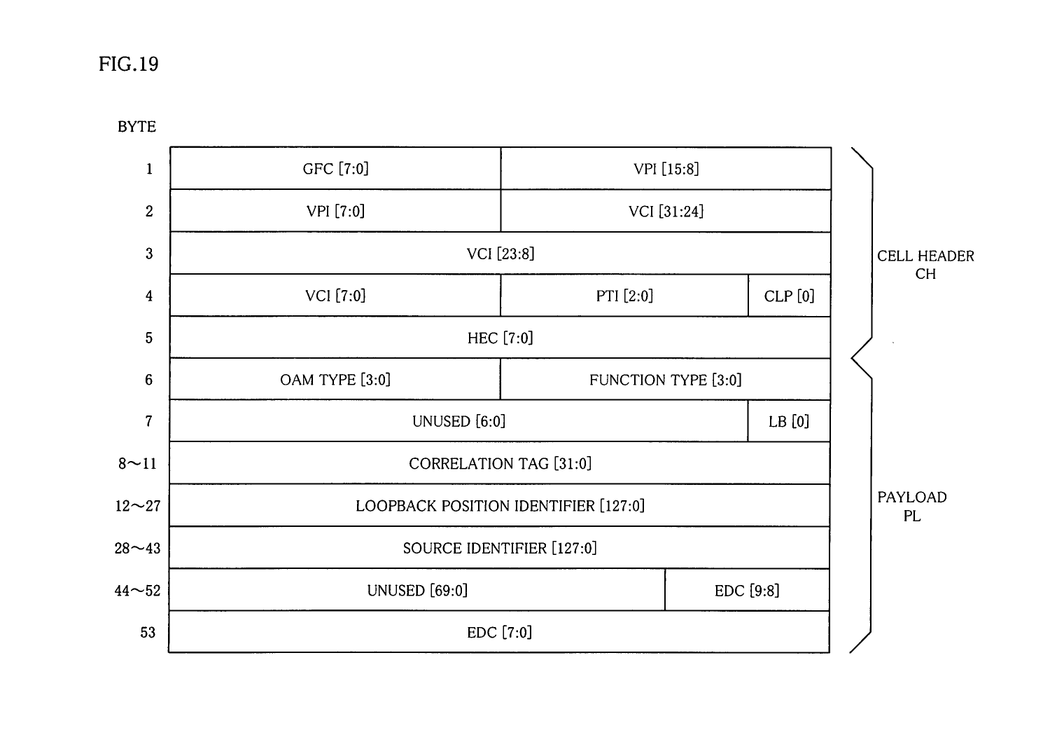

The OAM cell will now be described. FIG. 19 shows a format of an OAM cell. An F4-OAM cell has a value of VCI=3 or VCI=4 (where VPI is arbitrary):
The loopback cell has a value of OAM Type=0x1. Function Type=0x8.
“1” is set to the loopback position identifier upon transmission, and “0” is rewritten upon loopback. Thus, it is identified whether the received OAM cell is the cell looped back from the opposed device or the cell (to be looped back) inquired.
A correlation tag is generally a testing area, which a user can arbitrarily set.
All “1” is generally set to a source identifier.
An EDC is an error detection code (CRC-10) for the ATM payload information.

In operation, the OAM cell generator 25 generates the OAM cell. The relay device mounting thereon the nonstandard AAL5 frame format, e.g. the Ethernet/ATM transmitter R13 of the relay device R1 sets the value of the correlation tag of the F4-OAM cell to a specific value A (A is an arbitrary value) to be transmitted to the cell multiplexer 22 as the loopback cell. The cell multiplexer 22 multiplexes the ATM cell from the ATM cell generator 4, the OAM cell from the OAM cell generator 25, and the loopback cell received from the ATM/Ethernet receiver independently of each other to be transmitted to the ATM/Ethernet receiver R31 of the opposed relay device R3.

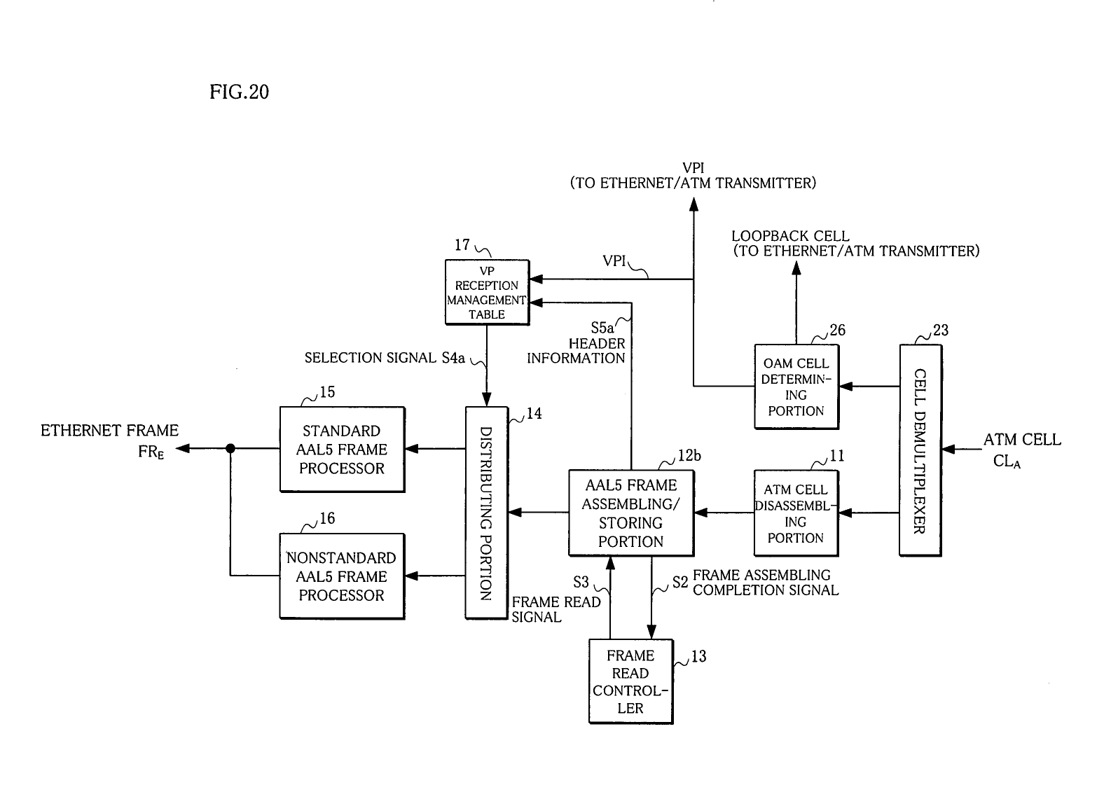

### Embodiment (7) of ATM/Ethernet Receiver: FIG. 20

This ATM/Ethernet receiver corresponds to the embodiment (7) of the Ethernet/ATM transmitter shown in FIG. 18, but is different from the ETM/Ethernet receiver of the embodiment (5) shown in FIG. 15 in that an OAM cell determining portion 26 is provided instead of the signaling cell terminator 24.

In the operation of the embodiment (7) of the Ethernet/ATM transmitter and the ATM/Ethernet receiver, if the relay device R31 mounts thereon the nonstandard AAL5 frame format, the cell demultiplexer 23 demultiplexes the ATM cells CL_{A} received from the Ethernet/ATM transmitter R13 into the OAM cell and the non-OAM cell, so that the OAM cell is transmitted to the OAM cell determining portion 26.

The OAM cell determining portion 26 determines whether or not the OAM cell is the loopback cell by checking an OAM type.

When the OAM cell is the loopback cell, the loopback cell position identifier is checked.

If the loopback cell position identifier=1, the loopback cell position identifier is rewritten to 0 and the correlation tag is checked. As a result, if the value of the correlation tag is the specific value A, the correlation tag is overwritten by another specific value B (B is an arbitrary value where B≠A) to be transmitted to the Ethernet/ATM transmitter R32 within the same relay device R3 as the loopback cell which is to be looped back. If the value of the correlation tag is not the specific value A, the correlation tag is not rewritten, and is likewise transmitted to the Ethernet/ATM transmitter R32 as the loopback cell.

The loopback cell from the ATM/Ethernet receiver R31 is transmitted to the cell multiplexer 22 shown in FIG. 18 within the Ethernet/ATM transmitter R32, and is transmitted to the ATM/Ethernet receiver R14 of the relay device R1 as the loopback cell.

This loopback cell is received by the ATM/Ethernet receiver R14 of the relay device R1 as a transmitting source, and is demultiplexed into the OAM cell and the non-OAM cell by the cell demultiplexer 23, so that the OAM cell is transmitted to the OAM cell determining portion 26. The OAM cell determining portion 26 checks the loopback position identifier. In the case of the loopback position identifier=0, it is determined to be the returned loopback cell, and the correlation tag is checked. As a result, if the value of the correlation tag is the specific value B, it is determined that the opposed relay device R3 mounts thereon the nonstandard AAL5 frame format, in which the opposed relay device R3 transmits the VPI from the OAM cell determining portion 26 to the VP reception management table 17 and the VP transmission management table 5 in the Ethernet/ATM transmitter R13. Based on the received VPI, it is set in the table that the AAL5 frame format selected for the concerned VPI is a nonstandard form.

As described above, this embodiment determines whether or not the opposed relay device mounts thereon the nonstandard AAL5 frame format by using the OAM loopback cell, and enables the AAL5 frame format to be dynamically selected and set.

It is to be noted that while an area storing the specific value is an area of the correlation tag in the above description, an undefined area within the payload of the loopback cell may be used.

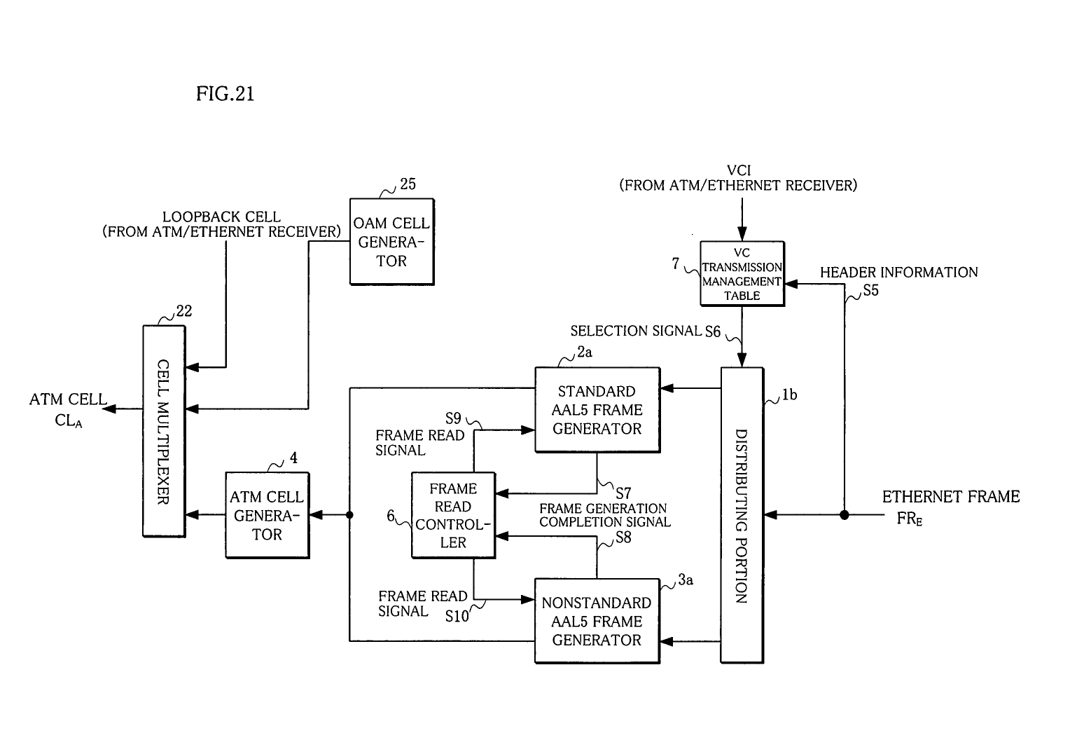

### Embodiment (8) of Ethernet/ATM Transmitter: FIG. 21

This Ethernet/ATM transmitter substitutes the VC transmission management table 7 for the VP transmission management table 5 in the embodiment (7) shown in FIG. 18.

However, in this embodiment, the mounting state of the AAL5 frame format of the opposed relay device is determined by using a loopback cell function of an F5-OAM cell. This F5-OAM is different from the F4-OAM, having PTI=100b or PTI=101b. Also, the F5-OAM is an OAM cell which is valid only for the VC connection indicated by the VPI/VCI held by the OAM cell. Namely, while the F4-OAM is for the VP connection, the F5-OAM is the OAM cell for the VC connection.

The payload components of the loop back cell of the F5-OAM cell are the same as those of the above-mentioned F4-OAM cell.

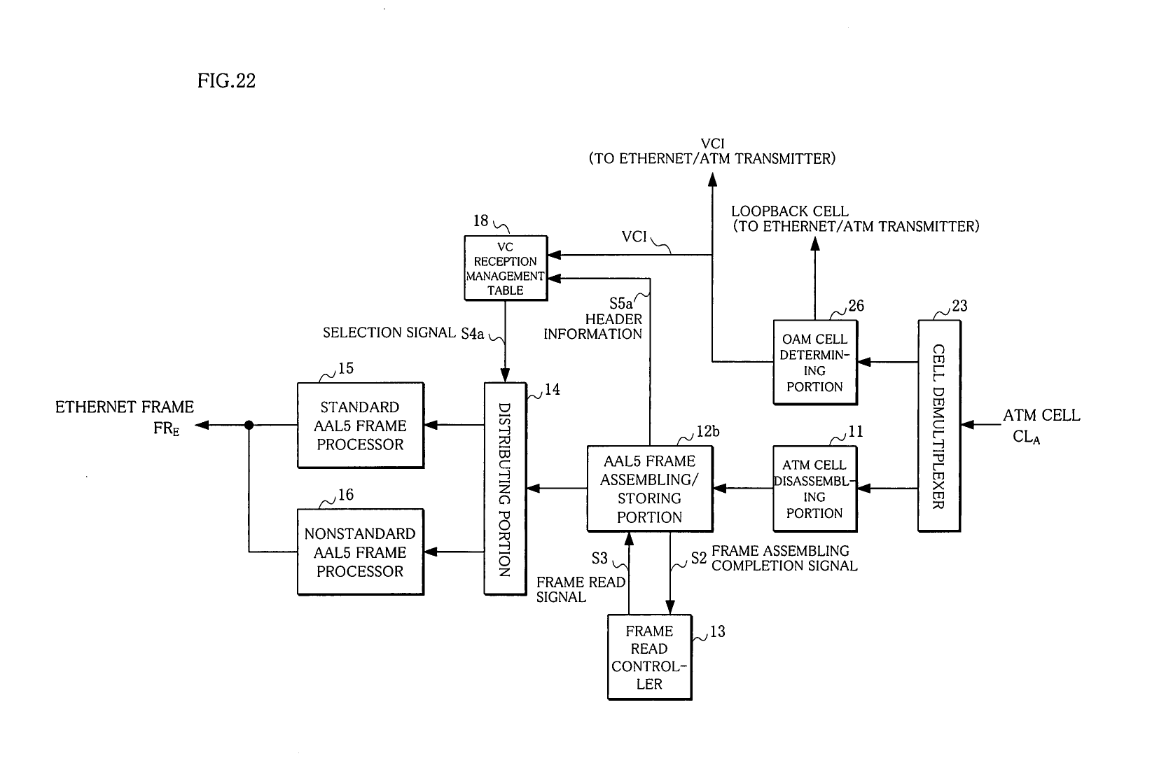

### Embodiment (8) of ATM/Ethernet Receiver: FIG. 22

The ATM/Ethernet receiver is different from the embodiment (7) shown in FIG. 20 only in that the VC reception management table 18 is substituted for the VP reception management table 17.

Since the VP management table and VP information are substituted for the VC management table and VC information, the operation is the same as that in the case of the VP connection.

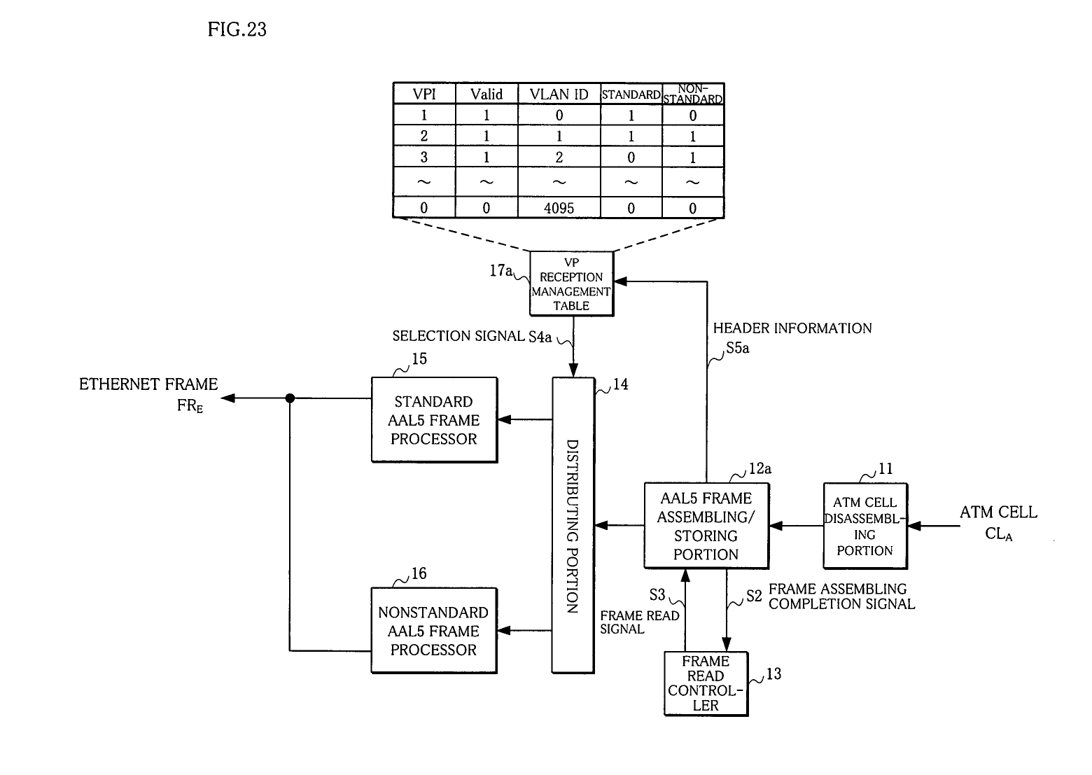

### Embodiment (9) of ATM/Ethernet Receiver: FIG. 23

While this ATM/Ethernet receiver is the same as that of the embodiment (3) shown in FIG. 11, it is permitted that “1” is set for both of the standard and nonstandard fields in the VP reception management table 17, different from the embodiment (3).

Namely, a standard AAL5 frame communication portion and a nonstandard AAL5 frame processor constantly perform AAL5 frame processing so that the relay device may not be disconnected even if the switchover of the AAL5 frame format is performed in the process of the communication when the above-mentioned dynamic setting is changed.

Namely, the ATM cell received from the ATM cell disassembling portion 11 is assembled into the AAL5 frame in the AAL5 frame assembling/storing portion 12a. Then, the header information S5a of the AAL5 frame concerned is transmitted to the VP reception management table 17a, and the AAL5 frame is transmitted to the distributing portion 14.

The distributing portion 14, according to the selection signal S4a from the VP reception management table 17a, transmits the AAL5 frame in which “1” is set for both of standard and nonstandard, to both of the standard AAL5 frame processor 15 and the nonstandard AAL5 frame processor 16 simultaneously. The processors 15 and 16 check frame formats of the AAL5 respectively, and process only the frame which is coincident with the frame format processed by its own processor. Then, the frame is transmitted to the Ethernet transmission line as the Ethernet frame FR_{E}. The frame which is not coincident with the frame format of its own processor is discarded, thereby enabling the standard AAL5 frame processor 15 and the nonstandard AAL5 frame processor 16 to perform exclusive processing of the AAL5 frame.

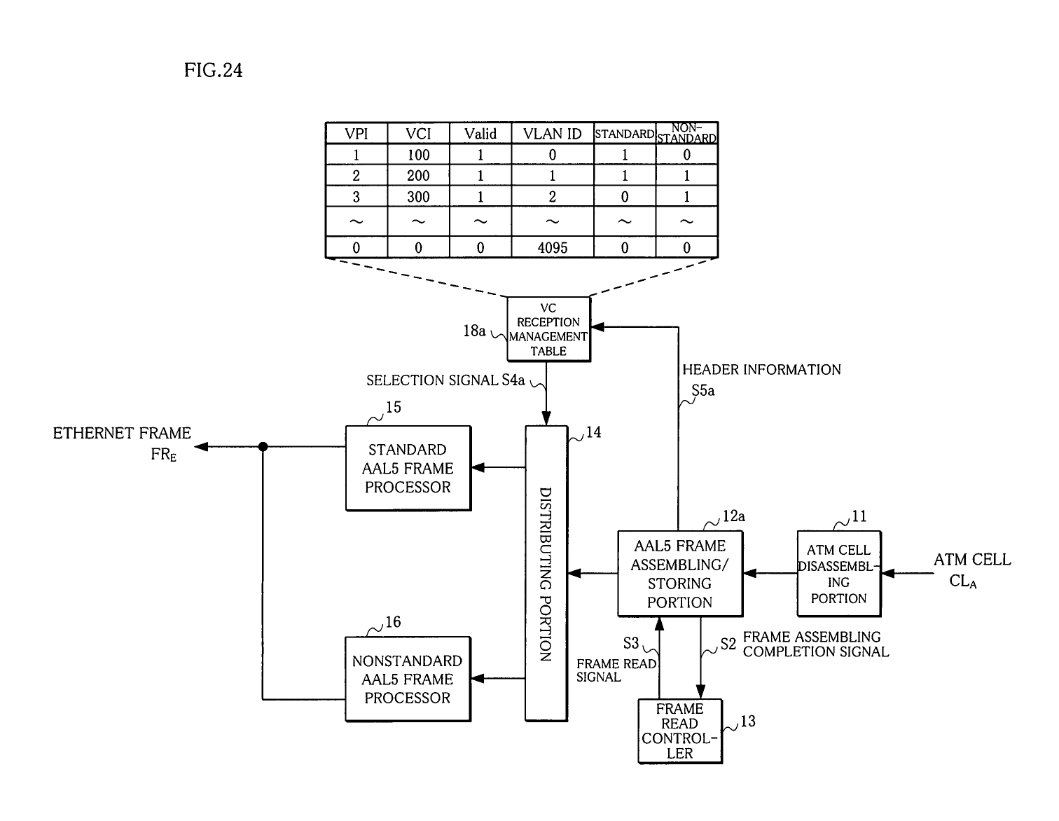

### Embodiment (10) of ATM/Ethernet Receiver: FIG. 24

In this embodiment, the VC reception management table 18a is substituted for the VP reception management table 17 in the embodiment (9) shown in FIG. 23, making it possible to set “1” for both of the standard and nonstandard fields in the VC reception management table 18a. Other operation is the same as that in case of FIG. 23.

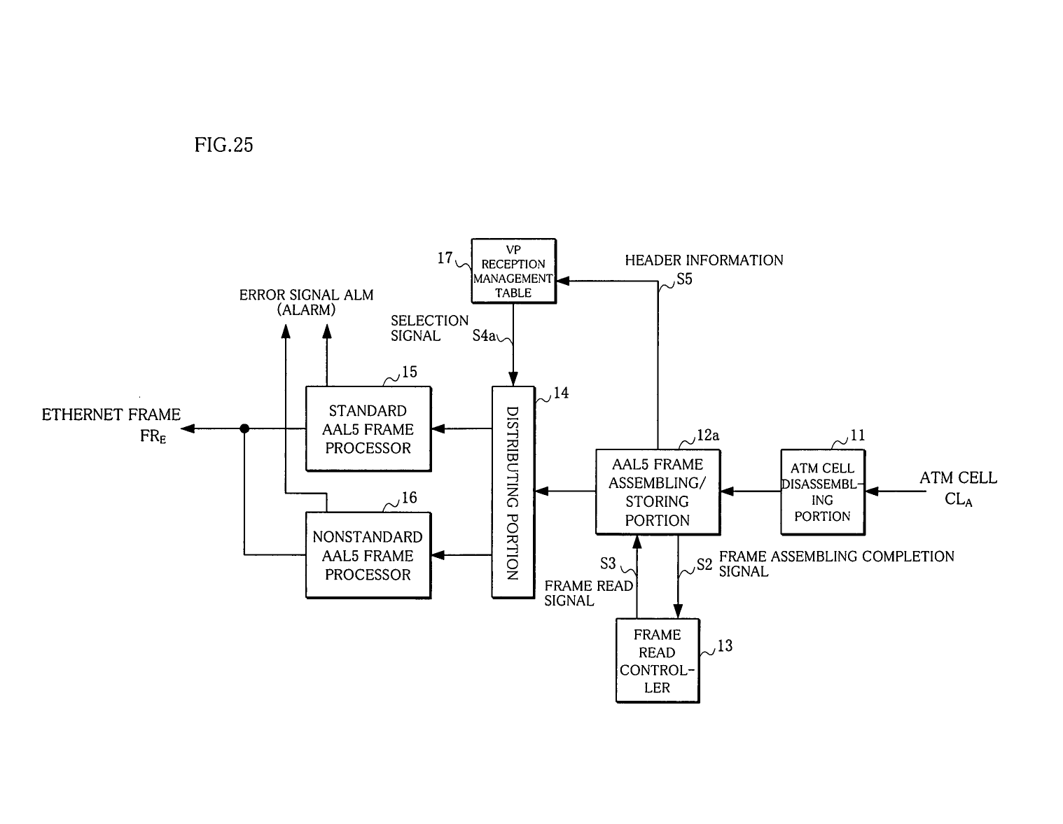

### Embodiment (11) of ATM/Ethernet Receiver: FIG. 25

While this ATM/Ethernet receiver is the same as that of the embodiment (3) shown in FIG. 11 or the like, this embodiment is different from others in that an error signal (alarm) ALM is generated in the frame processors 15 and 16.

Namely, when the AAL5 frame from the AAL5 frame assembling/storing portion 12a is provided to the frame processor 15 and/or the frame processor 16 by the distributing portion 14, and the frame is not a frame handled by the processor itself, each processor generates the error signal ALM indicating an abnormal state (alarm), and displays the state of the error signal as necessary on the screen of an operator terminal connected to the processor within the device and to the device or an operator terminal remotely connected. Also, in the presence of a lamp indication such as an LED indication in the device, a lamp indication can be performed as necessary. This embodiment is specifically effective in the case of the embodiments shown in FIGS. 23 and 24.

Thus, an abnormal state upon improper setting of the AAL5 frame format can be determined.

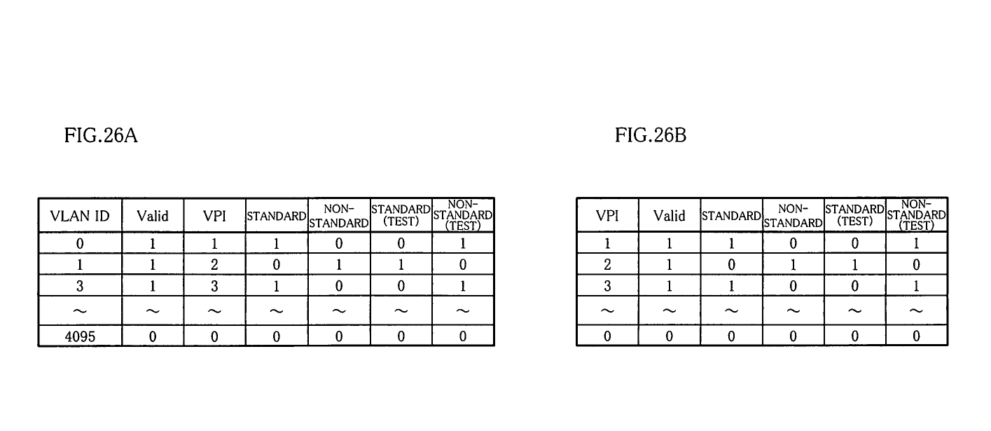

### Modification of Management Table: FIGS. 26A and 26B

FIG. 26A shows a modification of a VP transmission management table, and FIG. 26B shows a modification of the VP reception management table. In the tables, fields for standard (test) and nonstandard (test) are newly provided. This is because the AAL5 frame format different from the AAL5 frame format dynamically selected as mentioned above is compulsorily set or reset per connection. Namely, while “0” is set in the field of test under the normal operation state, “1” is compulsorily set upon testing.

Thus, a different AAL5 frame format is compulsorily set in an evaluation test or the like upon device development, thereby enabling an evaluation to be performed as to whether an abnormal state and an alarm can be normally detected on the opposed side. Similarly, by compulsorily releasing the setting, whether or not normal processing is recovered from abnormal processing on the opposed side can be also evaluated.

While FIGS. 26A and 26B show the VP management table, the VC management table can be dealt with by providing the fields of the standard (test) and the nonstandard (test) for this test.

It is to be noted that there is a method of achieving this test function by compulsorily overwriting the standard and the nonstandard settings by setting for test without providing a test field within the table. However, since the settings are overwritten in this method, it is difficult to simultaneously confirm if a function of dynamic setting operates normally upon testing and whether or not the AAL5 frame selection setting accurately operates. Accordingly, it is significant to provide fields for test within the table as shown in FIGS. 26A and 26B.

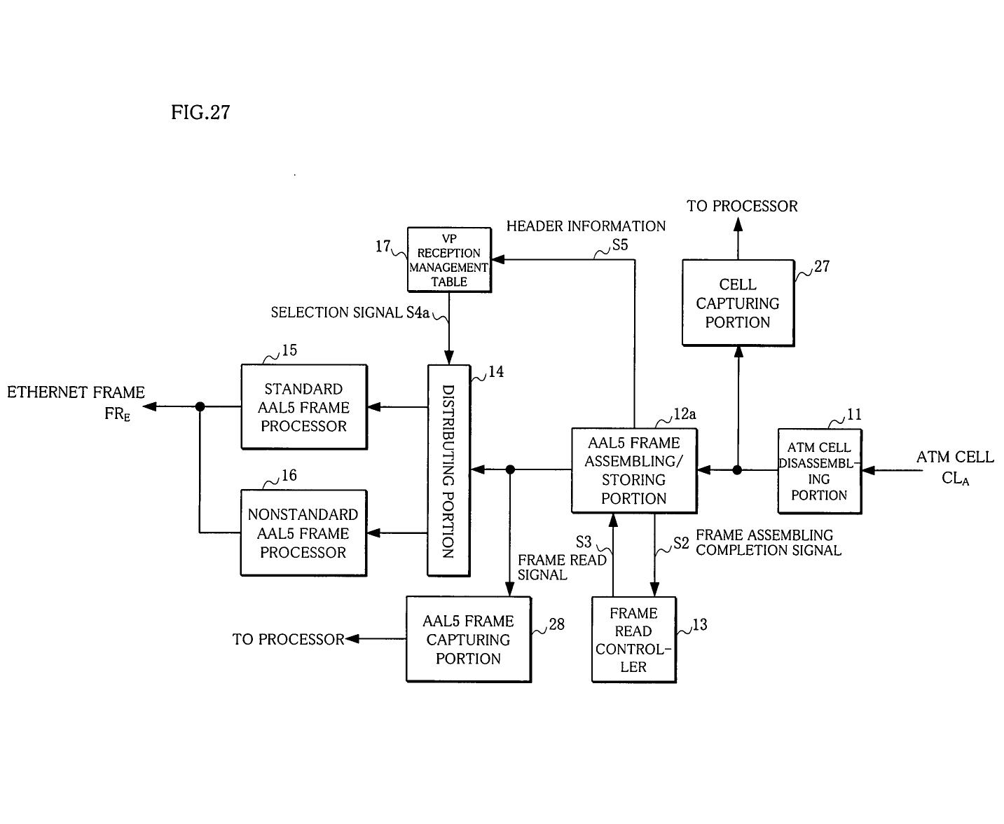

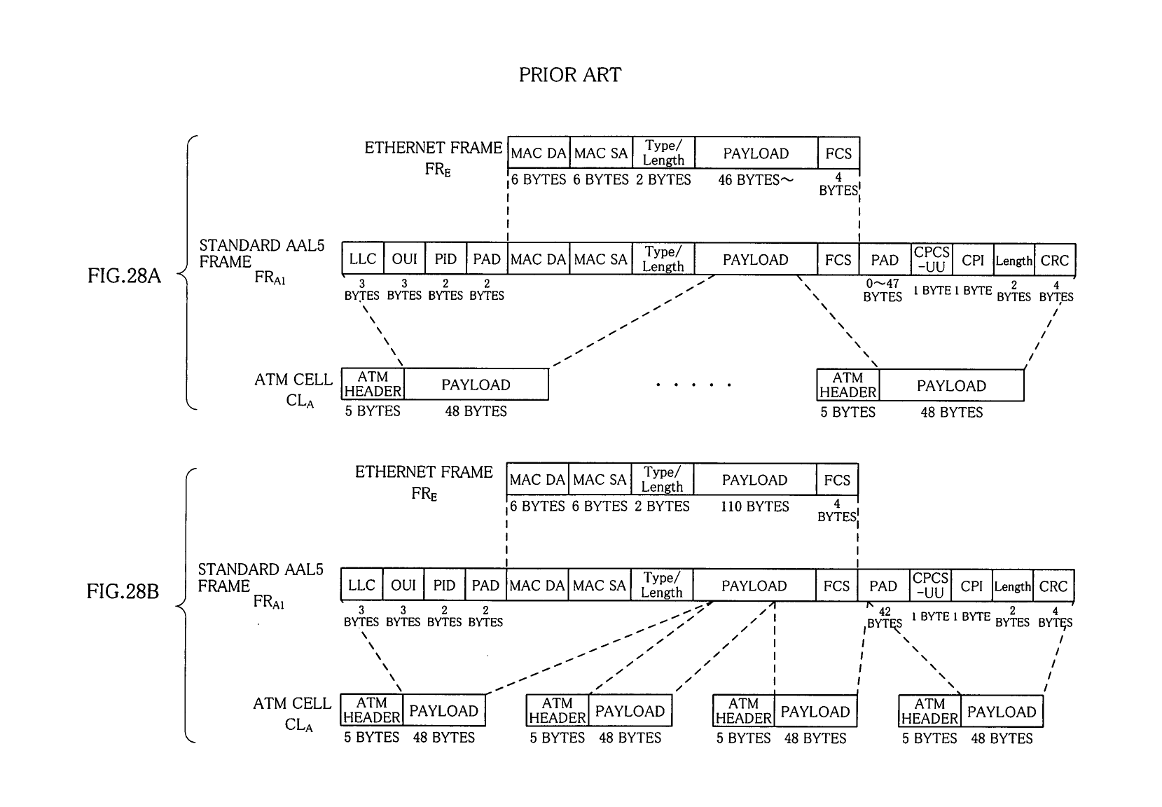

### Embodiment (12) of ATM/Ethernet Receiver: FIG. 27

The ATM/Ethernet receiver is different from that in the embodiment (3) of FIG. 11 or the like in that a cell capturing portion 27 for taking out the ATM cell outputted from the ATM cell disassembling portion 11 is connected and an AAL5 frame capturing portion 28 for taking out the AAL5 frame outputted from the AAL5 frame assembling/storing portion 12a is provided.

By designating the header information (VPI and VCI) of the ATM cell, the AAL5 frame concerned is stored in the cell capturing portion 27. The cell capturing portion 27 incorporates a storage element such as memory, and can store a plurality of AAL5 cells according to its size.

By designating the header information (VPI and VCI) of the ATM cell to the AAL5 frame capturing portion 28, the AAL5 frame concerned is stored in the cell capturing portion 28. The AAL5 frame capturing portion 28 also incorporates the storage element such as memory, and can store a plurality of AAL5 frames according to its size.

Also, the stored ATM cell and the AAL5 frame have an interface with a processor (not shown) within the device, making it possible to display information read through the professor on the screen of the operator terminal connected to the relay device or the operator terminal remotely connected as necessary.

Thus, it becomes possible to make an error analysis easy by capturing the AAL5 frame when an error of the AAL5 frame is frequently detected.

### Other Embodiments

(1) As mentioned above, the state of the AAL5 frame format dynamically selected per VPI/VCI connection may be displayed as necessary on the screen of the operator terminal connected to the relay device or the operator terminal remotely connected.

Thus, it becomes possible for an operator and a network manager to determine which AAL5 frame format is operated per connection.

As a specific example, by reading the contents of the VP management table or the VC management table through the processor within the device, and by displaying the contents on the screen, which AAL5 frame format is operated can be determined. Also, not only displaying but also enabling the setting control of the VP management table or the VC management table through the operator terminal, the test setting of FIGS. 26A and 26B can be remotely operated or the like.
(2) In addition, when the nonstandard AAL5 frame format is selected, compared with the case where the standard AAL5 frame format is selected, how much transmission efficiency is improved per connection is calculated, and the calculation result can be displayed as necessary on the screen of the operator terminal connected to the relay device or the operator terminal remotely connected.

Even in the case of the VPI/VCI connection having selected the nonstandard AAL5 frame format, the number of transmission cells is automatically calculated when the frame is converted into the AAL5 frame as the standard AAL5 frame format and into the ATM cells, and the number of cells is secured as a parameter, thereby enabling which AAL5 frame format is operated to be determined. The calculation of the number of cells can be simply performed by the following equation:

Equation: Roundup{(the number of bytes of Ethernet frame length+the number of bytes of AAL5 additional information)/48 bytes}

, where the Roundup means to round up a fractional part.

By continuously adding the ATM cells calculated by this equation as a parameter, and by comparing the number of actual transmission ATM cells transmitted by the nonstandard AAL5 frame format, a transmission efficiency result can be displayed.

For example, when the number of actual transmission ATM cells upon selecting nonstandard AAL5 frame is 100, and the number of transmission ATM cells when the standard AAL5 frame acquired by the above-mentioned equation is assumed is 125, it is found that the improvement of 125% (125 cells/100 cells×100) transmission efficiency can be obtained.

It is to be noted that the present invention is not limited by the above-mentioned embodiments, and it is obvious that various modifications may be made by one skilled in the art based on the recitation of the claims.

What is claimed is:

1. A network relay method comprising:
a first step of generating, from a variable length frame of a predetermined specification, a frame of a nonstandard frame format in which header information free from troubles in an end-to-end transfer even if the information is deleted from a standard frame format for inter-layer conversion is deleted therefrom; and
a second step of generating a plurality of ATM cells from the frame of the nonstandard frame format.

2. A network relay method comprising:
a first step of extracting payloads of a plurality of ATM cells and assembling the payloads into a frame;
a second step of generating, from header information of a frame assembled at the first step, a selection signal indicating whether a preset value of VPI or VCI in the header information corresponds to either a standard frame format for inter-layer conversion or a nonstandard frame format in which the header information free from troubles in an end-to-end transfer even if the information is deleted from the standard frame format is deleted therefrom; and
a third step of generating a variable length frame of a predetermined specification from the frame of the standard frame format or the nonstandard frame format assembled at the first step based on the selection signal.

3. The network relay method as claimed in claim 2, further comprising a step of inquiring of an opposed device whether or not the opposed device can deal with either the standard frame format or the nonstandard frame format and of generating the selection signal corresponding to either the VPI or the VCI upon inquiry.

4. The network relay method as claimed in claim 3, wherein the inquiry is performed by using a signaling cell or an OAM cell.

5. The network relay method as claimed in claim 2, further comprising a step of compulsorily setting or releasing the selection signal per VPI or VCI so as to correspond to the standard frame format or the nonstandard frame format.

6. The network relay method as claimed in claim 1, wherein the variable length frame comprises an Ethernet frame, and the standard frame format of the predetermined specification comprises a standard AAL5 frame format prescribed by RFC 1483 or RFC 2684.

7. The network relay method as claimed in claim 1, wherein the header information deleted includes FCS information.

8. The network relay method as claimed in claim 1, wherein the nonstandard frame format uses BIP 8 or BIP 16 as error detection information.

9. A network relay device comprising:
a first means generating, from a variable length frame of a predetermined specification, a frame of a nonstandard frame format in which header information free from troubles in an end-to-end transfer even if the information is deleted from a standard frame format for inter-layer conversion is deleted therefrom; and
a second means generating a plurality of ATM cells from the frame of the nonstandard frame format.

10. A network relay device comprising:
a first means extracting payloads of a plurality of ATM cells generated from a frame of a nonstandard frame format in which header information free from troubles in an end-to-end transfer even if the information is deleted from a standard frame format for inter-layer conversion is deleted therefrom and of assembling the frame of the nonstandard frame format; and
a second means generating a variable length frame of a predetermined specification from the frame of the nonstandard frame format assembled by the first means.

11. The network relay device as claimed in claim 10, wherein the second means includes a third means generating, from header information of a frame assembled by the first means, a selection signal indicating whether a preset value of VPI or VCI in the header information corresponds to either the standard frame format or the nonstandard frame format; and a fourth means generating the variable length frame from the frame of the standard frame format or the nonstandard frame format assembled by the first means based on the selection signal.

12. The network relay device as claimed in claim 11, further comprising a means inquiring of an opposed device whether or not the opposed device can deal with either the standard frame format or the nonstandard frame format and generating the selection signal corresponding to either the VPI or the VCI upon inquiry.

13. The network relay device as claimed in claim 12, wherein the inquiry is performed by using a signaling cell or an OAM cell.

14. The network relay device as claimed in claim 11, wherein the selection signal has a signal enabling a selection of frames of both frame formats; and
the fourth means includes, when the selection signal generated by the third means selects both of the frame formats, a fifth means generating the variable length frame only when the frame assembled by the first means corresponds to the standard frame format, and a sixth means generating the variable length frame only when the frame assembled by the first means corresponds to the nonstandard frame format.

15. The network relay device as claimed in claim 14, further comprising a means generating an alarm signal when it is determined that the frame does not correspond to the standard frame format by the fifth means and the format does not correspond to the nonstandard frame format by the sixth means.

16. The network relay device as claimed in claim 11, further comprising a means compulsorily setting or releasing the selection signal per VPI or VCI so as to correspond to the standard frame format or the nonstandard frame format.

17. The network relay device as claimed in claim 11, further comprising a means capturing and displaying the ATM cell or the standard frame format per frame.

18. The network relay device as claimed in claim 9, wherein the variable length frame comprises an Ethernet frame, and the standard frame format of the predetermined specification comprises a standard AAL5 frame format prescribed by RFC 1483 or RFC 2684.

19. The network relay device as claimed in claim 9, wherein the header information deleted includes FCS information.

20. The network relay device as claimed in claim 9, wherein the nonstandard frame format uses BIP 8 or BIP 16 as error detection information.
